(19) United States
(12) Patent Application Publication
(10) Pub. No.: US 2013/0304469 A1
(43) Pub. Date: Nov. 14, 2013

(54) INFORMATION PROCESSING METHOD AND APPARATUS, COMPUTER PROGRAM AND RECORDING MEDIUM

(71) Applicant: Mynd Inc., Tokyo (JP)

(72) Inventors: Tomihisa KAMADA, Tokyo (JP); Keisuke HARA, Tokyo (JP)

(21) Appl. No.: 13/872,841

(22) Filed: Apr. 29, 2013

(30) Foreign Application Priority Data
May 10, 2012 (JP) 2012-108731

(51) Int. Cl. G10L 15/02

(52) U.S. Cl. CPC G10L 15/02
USPC 704/239

(57) ABSTRACT

Among multiple documents presented to a user, a high interest and a low interest document are specified, a word group in the high interest document is compared with a word group in the low interest document, and a string of word groups associated weight values is generated as a user feature vector. A word group included in each of multiple data items targeted for assigning priorities is extracted, and data feature vectors are generated specific to each data item, based on the word groups extracted. A degree of similarity between each data feature vectors of multiple data items and user feature vector is obtained, and according to the degree of similarity, priorities are assigned to the multiple data items to be presented to the user. Therefore, it is possible to extract user's feature information on which the user's interests and tastes are reflected more effectively.

### BACKGROUND OF THE INVENTION

1. Field of the Invention

The present invention relates to an information processing method and apparatus, computer program and recording medium, for performing a process considering individual user's interests and tastes.

2. Description of the Related Art

Currently, a tool for accessing the Internet is not limited to a fixed terminal such as a personal computer (PC), but a cellular phone, or a portable information terminal so-called a smartphone, is utilized, enabling anytime and anywhere access to the Internet. In recent years, a TV receiver provided with a function for accessing the Internet is distributed generally.

In addition to the service such as a website, blog, and e-mail, following service is becoming pervasive; information service for posting a relatively short sentence, referred to as “Twitter (registered trademark)”, social networking service (SNS) such as “Facebook (registered trademark)” and “mixi (registered trademark)”. Thus, information on the Internet grows explosively and it is expected to continue to increase in the future.

On the other hand, since time available for one human being is limited, a quantity of useful information per unit of time used by a use on the Internet is reduced, and it is conceivable that this useful information quantity continues to decrease further in the future. Display space of each of the aforementioned various devices to access the Internet becomes wider but it is still restricted, and this limits the information displayable at one time.

From this point of view, it is possible to say that a substantial challenge from the side of a user who utilizes the Internet as one of the media, is “how to acquire information being wished with a high degree of efficiency”, and on the other hand, a challenge from the side of a provider for providing the user with information, is “how to provide information that the user wishes with a high degree of efficiency”.

There is known conventionally an information service site on the web, so called “portal site”, which is established in the viewpoint of “how to acquire information being wished with a high degree of efficiency”. On the portal site, information is organized by category and presented to the user, thereby allowing the user to acquire desired information easily.

As another method, there is also known a site that offers information search service based on a keyword. In this type of information search site, when a large number of data hits are presented to a user after a search, the order of the data items is determined by utilizing collective intelligence, such as information of site reference relations and frequency of searching.

The social networking service is advantageous because it allows an inquiry to a trusted friend, and this works as collective intelligence to acquire information efficiently.

On the other hand, with regard to the subject that “how to provide information that the user wishes with a high degree of efficiency”, there has been conventionally suggested a method for placing advertisement as described in the Japanese Unexamined Patent Application Publication No. 2004-118716. In this conventional technique, a document designated by a user is described in a vector format based on multiple attribute values indicating features of the document, vectors of a group of documents being designated are combined so as to calculate a vector representing the user's tastes, an advertisement as a candidate to be presented is described in a vector format based on multiple attribute values indicating features of the advertisement, a degree of similarity between the vector representing the user's tastes and the vector representing the feature of the advertisement is calculated, and the advertisement with a high degree of similarity is presented on a priority basis. As the attributes constituting the vector, a field in which the user shows interest, the advertisement, and the document itself are taken as examples.

More specifically, in the case where the vector representing individual user's tastes and the vector of the document are generated automatically, a keyword is extracted from the document designated by the user or the document indicating a feature of the advertisement, and an attribute ID in association with the keyword is utilized to generate the vectors. As a method for extracting the keyword, there are shown a method for subjecting an inputted text to morphological analysis to extract all independent words, a method for extracting a word determined as being emphasized contextually in a sentence, or a method for extracting a word represented in a highlighted format or a word provided with a link.

Similarly, the Japanese Unexamined Patent Application Publication No. 2003-178075 suggests an information processing apparatus and an information processing method for presenting related information in response to a situation without missing the timing. In this conventional technique, an inner product is obtained between a document feature vector associated with event occurrence upon mail sending or receiving, and a feature vector of topics (document group), and a degree of similarity therebetween is calculated. In addition, with regard to the feature vector of topics, if the total number of all topical words (feature words) is n, the feature vector of all the topics is expressed in the form of a vector in the n-dimensional space. In other words, it is disclosed to use the n-dimensional vector being generated based on weights of multiple words.

More specifically, contents of the document group (topics) are extracted and subjected to the morphological analysis to categorize them into words (feature words), and words being distributed across a wide range (e.g., part of speech such as “hello”, “regards”, and “please”, other than noun) are excluded as unnecessary words. After excluding such unnecessary words, frequency of occurrence of each word and a distribution state thereof across multiple documents are obtained, computing weight of each word with respect to each topic (a value indicating a degree how much relating to the gist of the document), and accordingly, a feature vector is calculated with respect to each topic, provided with weight of each word as a constitutional element.

In the various conventional techniques as described above, a portal site is now providing enormous amount of information, with increasing the depth of the hierarchy, and therefore it is getting troublesome and more difficult for a user to search for targeted information.

The search service based on a keyword may present not only necessarily new information, but also a lot of old information in mixed manner, and therefore there is a disadvantage that it lacks a feature of real-time.

In the social networking service, it is a kind of inconvenient to make inquires to a friend for each case, taking time for follow-up, and so on, and thus these are also considered as having disadvantages.

In generating a vector representing user's tastes as described in the Japanese Unexamined Patent Application Publication No. 2004-118716, there are problems as the following: If the method for subjecting an inputted text to morphological analysis and extracting all independent words is employed, the extracted independent words do not necessarily reflect the user's taste effectively; it is not necessarily easy to determine which word is emphasized contextually in the sentence so as to be extracted; and it is not possible to reflect the user's tastes sufficiently only by the use of a word being shown with a highlighted font or a word provided with a link, and so on.

In generating a vector representing the user's taste as described in the Japanese Unexamined Patent Application Publication No. 2003-178075, even though unnecessary words are excluded according to the method as described above, such exclusion of unnecessary words may be one-size-fits-all for every user, and in some cases, this may be inappropriate. In addition, in order to exclude unnecessary words, it is required to store predetermined unnecessary words in advance and perform a discriminant analysis on a part of speech, and thus this makes the processing more complicated.

### SUMMARY OF THE INVENTION

With the background as described above, the present invention is directed to an information processing method and an information processing apparatus considering individual user's interests and tastes, in order to provide a technique which enables extraction of user's feature information reflecting the user's interests and tastes according to a relatively simple method.

An information processing method in an information processing apparatus according to the present invention comprises the steps of: generating a user feature vector specific to a user; extracting a word group included in each of multiple data items targeted for assigning priorities to generate a data feature vector specific to each data item based on the word group extracted; obtaining a degree of similarity between each of the data feature vectors of the multiple data items and the user feature vector; and assigning priorities to the multiple data items to be presented to the user, according to the degree of similarity obtained. In the step of generating the user feature vector, a document of high interest in which a user expresses interest and a document of low interest in which the user expresses no interest are specified according to the user's operation among multiple documents presented to the user, a word group included in the document of high interest and a word group included in the document of low interest are compared with each other, a weight value of a word included commonly in both documents is set to zero, the weight value of a word included only in the document of high interest is set to a non-zero value, and a string of the weight values in association with the word groups is generated as the user feature vector.

The present invention is, particularly, characterized in that in the point that generation of the user feature vector is performed based on both the word group included in the document of high interest and the word group included in the document of low interest. Accordingly, it is possible to remove noise (described below) in association with individual users, not one-size-fits-all type noise.

In the step for obtaining the degree of similarity, each of the data feature vectors of the multiple data items targeted for assigning priorities and the user feature vector are compared with each other, and a product sum of the weight values of the words being associated with each other between both feature vectors is obtained as the degree of similarity. In the step for generating the user feature vector, a word group included only in the document of low interest is further extracted, weight values different in signs are added, respectively to the word included only in the document of high interest and to the word included only in the document of low interest, and the weight values of those words are combined, thereby obtaining the user feature vector. Accordingly, it is possible to generate a vector that emphasizes the feature of the user.

The document of high interest is a document which has received at least one of the following user's instructions, for example; an explicit instruction from the user to display the document entirely as to which a part of the contents is already presented, an explicit instruction to express that the user likes the document being presented, an explicit instruction for saving the document (including clipping the document, and so on), and an explicit instruction for printing the document. In addition, a document posted by the user, a document to which the user provides a comment, or a document of the user's comment may also be the document of high interest.

The document of low interest may be at least one document in which the user expresses no interest, out of the multiple documents, when those multiple documents are presented all at once.

The document of low interest is stored, and in the case where a document becomes the document of high interest and no further new document of low interest is specified, the document of low interest already stored may be used for generating the user feature vector.

It is further possible to include a step of updating the user feature vector, upon obtaining a new user feature vector based on a new document presented to the user, by combining the new user feature vector with the user feature vector.

It is further possible to provide a step of reflecting the profile data of the user on the user feature vector by adding a word extracted from profile data of the user to the word group extracted from the document of high interest.

As for the word extracted from the profile data, an element value of the user feature vector is prevented from being affected by the updating. With this configuration, it is possible to avoid that reflection of the word extracted from the profile data on the user feature vector is getting to be diluted by updating the user feature vector.

In the step for generating the user feature vector, different word pairs included in one document are extracted with respect to each document, and a user feature tensor including the word pairs may be obtained instead of the user feature vector. In the step for obtaining the degree of similarity, vector magnitude obtained as a product of the user feature tensor and each of the data feature vectors of the multiple data items targeted for assigning priorities may be assumed as a degree of similarity between the data feature vector and the user feature tensor.

The information processing apparatus according to the present invention comprises a generating unit for generating a user feature vector specific to a user; a extracting unit for extracting a word group included in each of multiple data items targeted for assigning priorities to generate a data feature vector specific to each data item based on the word group extracted; an obtaining unit for obtaining a degree of similarity between each of the data feature vectors of the multiple data items and the user feature vector; and an assigning unit for assigning priorities to the multiple data items to be presented to the user according to the degree of similarity obtained. In the generating unit for generating the user feature vector, a document of high interest in which a user expresses interest and a document of low interest in which the user expresses no interest are specified according to the user's operation among multiple documents presented to the user, a word group included in the document of high interest and a word group included in the document of low interest are compared with each other, a weight value of a word included commonly in both documents is set to zero, the weight value of a word included only in the document of high interest is set to a non-zero value, and a string of the weight values in association with the word groups is generated as the user feature vector. In the obtaining unit for obtaining the degree of similarity, for example, each of the data feature vectors of multiple data items targeted for assigning priorities and the user feature vector are compared with each other, and a product sum of the weight values of the words being associated with each other between both feature vectors is obtained as the degree of similarity.

A computer program according to the present invention for allowing a computer to perform an information processing method in an information processing apparatus, comprising the steps of: generating a user feature vector specific to a user; extracting a word group included in each of multiple data items targeted for assigning priorities and generating a data feature vector specific to each data item based on the word group extracted; obtaining a degree of similarity between each of the data feature vectors of the multiple data items and the user feature vector; and assigning priorities to the multiple data items to be presented to the user according to the degree of similarity obtained. In the step of generating the user feature vector, a document of high interest in which a user expresses interest and a document of low interest in which the user expresses no interest are specified according to the user's operation among multiple documents presented to the user, a word group included in the document of high interest and a word group included in the document of low interest are compared with each other, a weight value of a word included commonly in both documents is set to zero, the weight value of a word included only in the document of high interest is set to a non-zero value, and a string of the weight values in association with the word groups is generated as the user feature vector. In the step of obtaining the degree of similarity, for example, each of the data feature vectors of multiple data items targeted for assigning priorities and the user feature vector are compared with each other, and a product sum of the weight values of the words being associated with each other between both feature vectors is obtained as the degree of similarity.

The present invention is also directed to a recording medium in which the aforementioned program is recorded in computer readable manner.

According to the present invention, it is possible to extract user feature information on which user's interests and tastes are reflected more effectively, according to a relatively simple method, in the information processing method and the information processing apparatus for performing a process considering individual user's interests and tastes. In particular, in generating the user feature vector, two documents; a document of high interest and a document of low interest are used, and it is possible to accentuate a feature peculiar to each user included in the user feature vector, not one-fits-all feature for all the users. As a result, according to the degree of similarity between each of the data feature vectors of the multiple data items and the user feature vector, it is possible to assign priorities to the multiple data items to be presented to the user, more appropriately.

### BRIEF DESCRIPTION OF THE DRAWINGS

FIG. 1 illustrates a schematic configuration of the overall system for providing service utilizing the Internet, according to an embodiment of the present invention;

FIG. 2 is a block diagram illustrating various functions of terminal 100 as shown in FIG. 1;

FIG. 3 is a block diagram illustrating various functions of service server 300 as shown in FIG. 1;

FIG. 4 is a block diagram illustrating various functions of WEB server 400 as shown in FIG. 1;

FIG. 5 is a flowchart illustrating a schematic procedure example of the information processing 1 according to an embodiment of the present invention;

FIG. 6 is a flowchart illustrating a schematic procedure example of information process 2 according to an embodiment of the present invention;

FIG. 7 is a flowchart illustrating a specific example of processing procedure for generating (updating) the user feature vector in steps S11 and S18, as shown in FIG. 5 and FIG. 6;

FIG. 8 illustrates a specific example of processing procedure for generating the data feature vector in step S13 as shown in FIG. 5;

FIG. 9 illustrates a specific example for generating the data feature vector according to an embodiment of the present invention;

FIGS. 10-10D illustrate screen examples of news provided on a specific site on the Internet according to an embodiment of the present invention;

FIG. 11 illustrates a screen example displayed in a social networking service (SNS);

FIG. 12 illustrates a different screen example displayed in the SNS;

FIGS. 13A and 13B illustrate screen examples in which posted information items are displayed in chronological order by Twitter (registered trademark), on a PC for displaying a relatively large screen and on a portable terminal for displaying a relatively small screen;

FIGS. 14A-14C illustrate a simplified example of a document of high interest, a document of low interest, and a user feature vector, which are specified from a group of documents;

FIG. 15 illustrates how to assign priorities to multiple data items targeted for assigning priorities, based on the user feature vector, in an embodiment of the present invention;

FIGS. 16A-16C illustrate an example for generating the user feature vector when a real number value is assigned to a word, in an embodiment of the present invention;

FIG. 17 illustrates a configuration example of a user feature tensor of second order, in an embodiment of the present invention;

FIGS. 18A-18C illustrate a specific example for generating the user feature tensor in an embodiment of the present invention;

FIGS. 19A and 19B illustrate an example of 3×3 matrix as a subset of the matrix as shown in FIG. 18C, showing an example for calculating the degree of similarity;

FIGS. 20A-20C illustrate a modification example for generating the user feature tensor in an embodiment of the present invention;

FIGS. 21A and 21B illustrate an example for calculating the degree of similarity as to the user feature tensor of 3×3 matrix, in association with the modification example of FIG. 20; and

FIG. 22 illustrates a second modification example according to an embodiment of the present invention.

### DESCRIPTION OF THE PREFERRED EMBODIMENT

Hereinafter, an embodiment of the present invention will be explained in detail, with reference to the accompanying drawings.

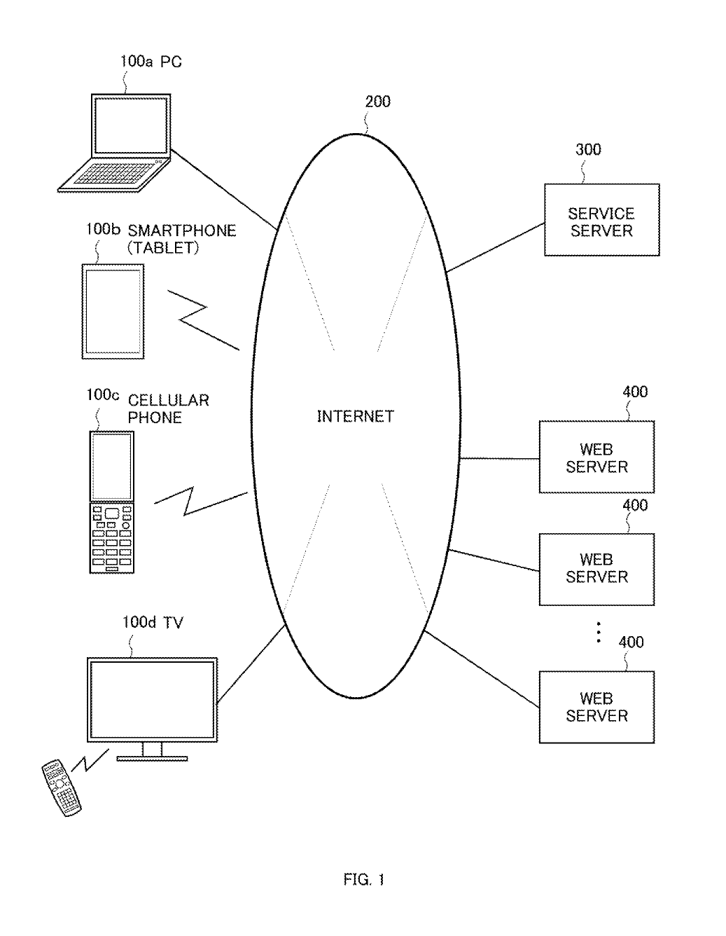

FIG. 1 illustrates a schematic configuration of an overall system for providing a service utilizing the Internet, according to an embodiment of the present invention.

Various tools exist for allowing a user to access the Internet 200 as a communication network. FIG. 1 shows a PC 100a, a smartphone (tablet) 100b, a cellular phone 100c, and a TV receiver 100d. The TV receiver 100d is illustrated here as a representative of a household electrical appliance, and various household electrical appliances other than the TV receiver may serve as the tool. All the tools as described above are generically called as a terminal (or an information terminal). In particular, the smartphone (tablet) 100b and the cellular phone 100c are referred to as a “portable terminal”.

Connected to the Internet 200 are a service server 300 for providing service relating to the present embodiment and multiple WEB servers 400, functioning as the devices on the side for providing the service. The WEB servers 400 serve as a website, a blog, and a site for providing the social networking service (SNS) such as Twitter (registered trademark), Facebook (registered trademark), and mixi (registered trademark).

The service on the service server 300 relating to the present embodiment projects individual user's interests and tastes upon the service of the Internet, efficiently determines information which is necessary for the user or information which seems to be necessary for the user, and presents such information to the user. When viewed from the user, the service server 300 provides a new information arrangement technique and service enabling “pull of information that the user wants” without performing any particular user operation.

A substantial function in the present embodiment is to assign priorities to “multiple data items”, according to the user's interests and tastes. The “data items” of the “multiple data items targeted for assigning priorities” may be basically text data made up of a character string. Text data associated with data of other media; for example, a static image such as a photograph, a moving picture, and music may also serve as the “data items”.

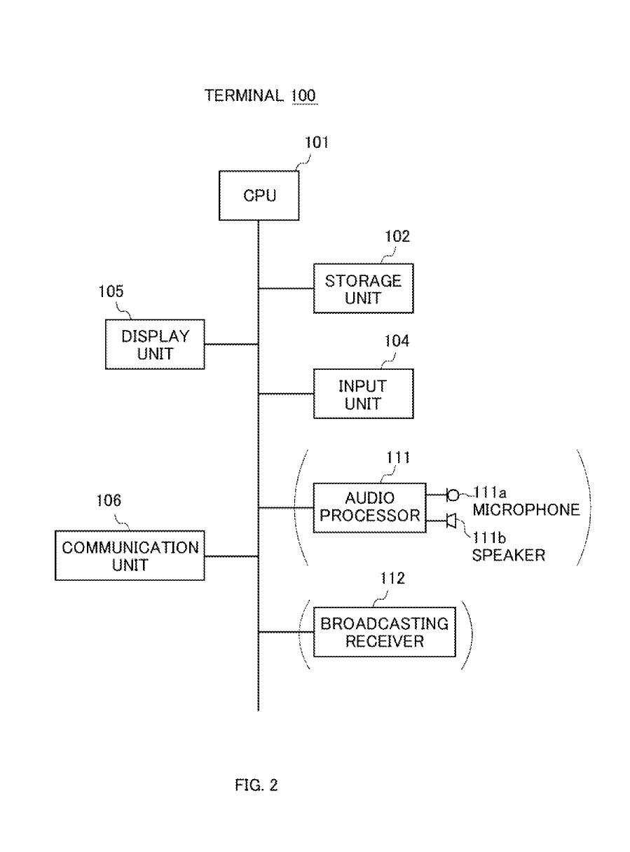

FIG. 2 is a block diagram showing various functions of the terminal 100.

The terminal 100 is provided with a CPU 101, a storage unit 102, an input unit 104, a display unit 105, and a communication unit 106. The terminal may also be provided with an audio processor 111, a microphone 111a, and a speaker 111b, for making a phone call and music player function, for example, which may be different depending on a type of the terminal. A terminal like the TV receiver 100d is provided with a broadcasting receiver 112. Though not illustrated, it is possible to provide individual terminals with a processor specific to each terminal.

The CPU 101 is connected to each of predetermined parts, executes a program stored in the storage unit 102 to establish a controller for controlling each part of the terminal 100, and realizes various functions (or means). The storage unit 102 includes a region for storing in non-volatile manner, fixed data such as fonts, in addition to computer programs, and a region as a work area or a temporary data storage area, utilized by the CPU 101. The storage unit 102 further includes a region for storing various documents and data acquired via the Internet 200 in non-volatile manner. The “document” in the present specification is a kind of data, and it is text data presented to the user, being utilized for generating a user feature vector as the user feature information.

The input unit 104 is a user interface for allowing a user to input various instructions and data in the terminal 100. Typically, the input unit may include various keys, such as a power key, a phone call key, a numerical keypad, and cursor operation keys. These keys may be hardware keys, or they may be provided in the form of software. The display unit 105 is a user interface for allowing the terminal 100 to provide display information to the user, and it may be a display device such as a liquid crystal display or an organic EL display. As the input unit 104, a touch panel may be provided, having a touch input area superimposed on the display screen of the display unit 105.

The communication unit 106 is a unit for establishing connection with the Internet 200, and it is a processing unit for establishing wireless communication with a base station of a cellar phone wireless system such as the third generation (3G) and the fourth generation (4G) via an antenna, thereby making a phone call or performing data communication with an intended party via the base station. In addition, as the communication part 106, already existing optional communication unit is available, such as the wireless LAN, and the BLUETOOTH (registered trademark).

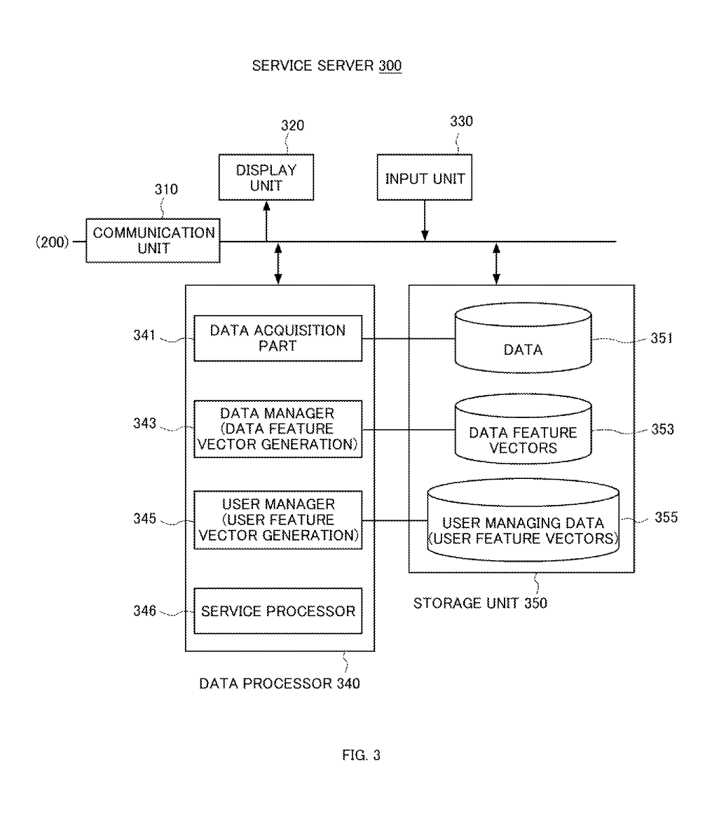

FIG. 3 is a block diagram showing various functions of the service server 300.

The service server 300 is provided with main function units, including a communication unit 310, a display unit 320, an input unit 330, a data processor 340, and a storage unit 350.

The communication unit 310 is a part such as a router, being connected to the Internet 200 for establishing data communication. The display unit 320 is a user interface for providing display information to maintenance personnel of the service server 300, and it may include any display device. The input unit 330 is a user interface for allowing the maintenance personnel to input various instructions and data to the service server 300, and it may be a keyboard, for instance.

The data processor 340 is a part including a CPU, and the like, for performing various control and necessary data processing of the service server 300. In the present embodiment, the data processor 340 incorporates a data acquisition part 341, a data manager 343, a user manager 345, and a service processor 346.

The storage unit 350 incorporates a data storage 351, a data feature vector storage 353, and a user managing data storage 355.

The data acquisition part 341 in the data processor 340 is a part for accessing the Internet 200 under the control of the service processor 346, and acquiring various data (documents) from a site or sites such as the WEB server 400. It is further possible to acquire data (e.g., user profile data, and the like), from the terminal 100. The data storage 351 stores the data thus acquired.

The data manager 343 generates a data feature vector based on the data acquired by the data acquisition part 341, and then, stores the data feature vector in the data feature vector storage 353 in association with the data.

The user manager 345 stores, in the user managing data storage 355, user's private information and a user feature vector, as user managing data with respect to each individual user. The private information may include, user authentication information (user ID, password, and the like) for providing service to a registered user, name, address, nickname, education background (or the school one graduated from), tastes, or the like.

The service processor 346 is a part that uses the data acquisition part 341, the data manager 343, and the user manager 345 to execute processing relating to the service to be provided to the user. As described above, this service projects individual user's interests and tastes upon the service of the Internet, efficiently determines information necessary (seems to be necessary) for the user, and presents the information to the user. Specifically, this service may include,

matching and recommending a product, human resources, and the like, for each user;

forecasting a thing optimized for the user;

filtering data optimized for the user; and

searching for data optimized for the user.

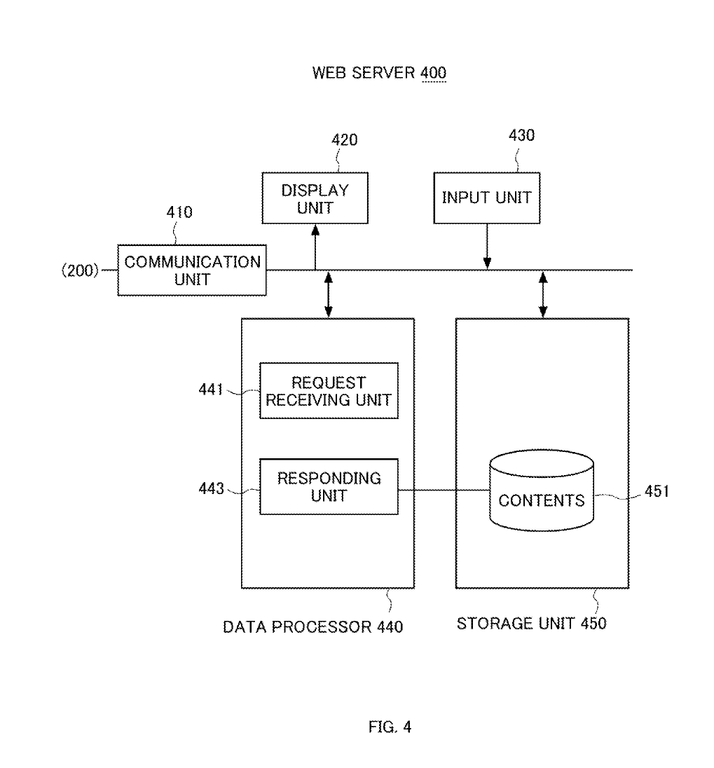

FIG. 4 is a block diagram showing various functions of the WEB server 400.

The WEB server 400 is provided with a communication unit 410, a display unit 420, an input unit 430, a data processor 440, and a storage unit 450.

The communication unit 410 is a part such as a router, for example, for establishing connection with the Internet 200 and performing data communication. The display unit 420 is a user interface including any display device for providing the display information to a maintenance personnel or the like, for the WEB server 400. The input unit 430 is a user interface allowing the maintenance personnel or the like, to input various instructions and data to the WEB server 400, and it may be a keyboard, for instance.

The data processor 440 is a part including the CPU and the like, for performing various control and necessary data processing of the WEB server 400. In the present embodiment, there are provided a request receiving unit 441 for accepting a request from a terminal (user) such as a contents request, via the communication unit 410, and a responding unit 443 for reading the contents being requested from the contents storage 451 within the storage unit 450 and responding to the terminal via the communication unit 410. Processing in the responding unit 443 may include associating processing such as search service.

Here, an explanation is given to a data feature vector in this specification.

A data feature vector is a dictionary for associate a word appearing in an article (or document) with its weight (i.e., a certain real number), thereby representing the feature of the article (or document). The feature vector can be represented as a function of words, or can also be represented as a vector if the words appearing in the article are fixed in their order as coordinates.

### Example A

A case in which weight is represented by a distribution of frequency of occurrence of each word appearing in a document.

c={cat: 0.12, moon: 0.03, book: 0.34, . . . }

This representation means that the word “cat” appears in the document with a percentage of 12%, the word “moon” appears in the document with a percentage of 3%, the word “book” appears in the document with a percentage of 34%. A form as a function is available like c (cat)=0.12. Also, a form of vector is available like c=(0.12, 0.03, 0.34, . . . )

### Example B

A case in which weight is represented by a set of words appearing in a document.

C={cat, moon, book, . . . }

This representation can be taken as a dictionary whose weights are all “1”. Alternatively, this representation can be taken as a function in which, for words included in the set, for instance, c(cat)=1, and all other words are given with zero.

### Example C

A case in which, as the weights in Example A, not only the frequency in the documents, but document frequency is also considered, where the document frequency indicates how frequently each word appears in documents, with a certain document group used as a reference. This example C includes TF-IDF (Term Frequency-Inverse Document Frequency) method which is known in the field of information search.

Next, operation of the present embodiment will be explained.

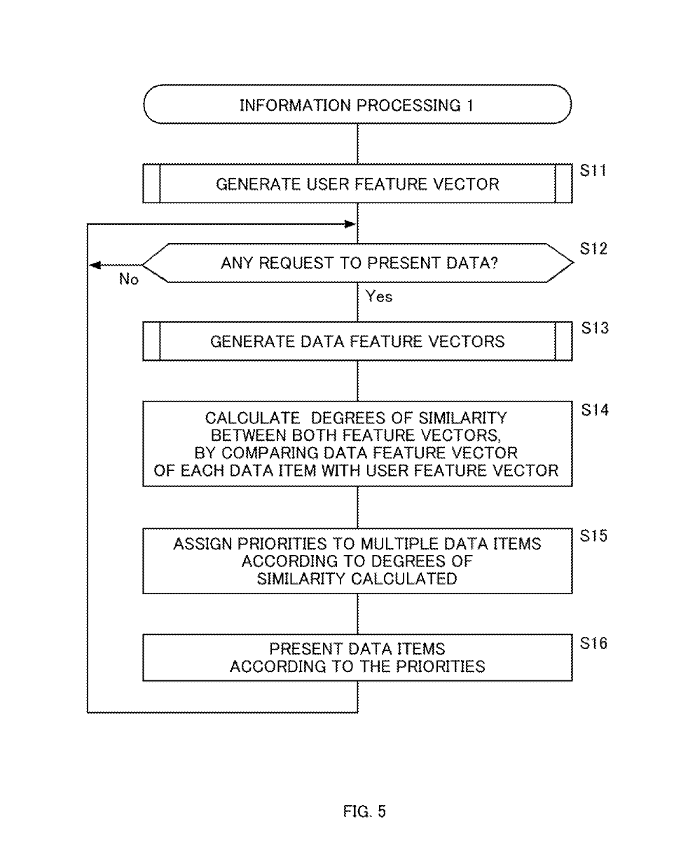

FIG. 5 illustrates a schematic procedure example of the information processing 1 according to the present embodiment. Typically, this information processing 1 is assumed as the network service (or cloud service) executed by the service server 300 as shown in the system of FIG. 1.

The information processing 1, firstly, generates for a specific user, a user feature vector which is information reflecting the user's interests and tastes (S11). The user feature vector UV in n-dimensions is represented by UV=[a1, a2, . . . , an]. Here, “a1, a2, . . . , an” represent n elements of the vector UV. The user feature vector UVj as to each user j may be expressed as the following:

UVj=[aj1,aj2, . . . , ajn]

Upon receipt of an instruction for presenting any data to the user (S12), the information processing generates data feature vectors each of which is information indicating a feature of the data, as to each data item targeted for the presentation (S13). The “instruction for presenting any data” may include, for example, a menu selection for displaying recommended information, an instruction for sorting the data items in the order of priority, or the like.

Here, the data feature vector of each data item is compared with the user feature vector so that a degree of similarity between both feature vectors is calculated (S14). By way of example, in order to decide the priority (or total order) of the data items Dj for the user j, an inner product value is calculated between the user feature vector UVj and the data feature vector DVi of the data Di, according to the following formula.

UVj·DVi=Σajm·wim (m=1, 2, . . . , n)

Here, “ajm” represents a value of m-th element of the user feature vector UVj of the user j, and “wim” represents a value of m-th element of the data feature vector of the data Di.

Priorities are assigned to the data items Di in descending order of the inner product values (the larger is the higher). Upon obtaining the inner product between the data feature vector and the user feature vector, it is necessary to bring the number of dimensions of both vectors to agree with each other. For this purpose, actually, it is sufficient to assume that the number of dimensions n, which corresponds to the total number of words being different between both vectors, instead of using the virtual maximum number of dimensions n as described in the following.

Next, according to the degrees of similarity thus calculated, priorities are assigned to the multiple data items (S15). In addition, the data items are presented (or processed) according to the priorities assigned (S16). In other words, a data item ranked higher is presented to the user on a priority basis. Specifically, various modes for presenting the data items are conceivable, depending on applications and conditions; only the data item with the highest priority is presented, a predetermined number of data items with high priority is chosen to be presented to the user, or all the data items are presented to the user in order of precedence. It is further possible to prepare a mode for presenting the data items, such as presenting multiple data items in stepwise manner according to the order of priority, in response to the user's request by request.

Steps S12 to S16 are executed repeatedly. A specific processing procedure and a processing example of each of those processing steps will be described in the following.

It is alternatively possible to execute the overall or a part of the processing of the information processing 1 as shown in FIG. 5 on the terminal side, not on the server side. As a configuration for implementing the processing, application software or plug-in software (for PC use, smartphone use, and others), and software incorporated in information processing equipment and household electrical appliances are taken as examples. In the case where generation and storage of the user feature vector are performed on the terminal side, it is also possible to generate the data feature vector, with calculating and determining the degree of similarity, on the terminal side. It is alternatively possible to configure such that the generation and storage of the user feature vector are performed on the terminal side, whereas generation of the data feature vector and calculating and determining the degree of similarity, are performed on the server side. In this case, the terminal transfers the generated and updated user feature vector to the server side. Those various configurations as described above may be similarly applicable to the information processing 2 that will be explained next.

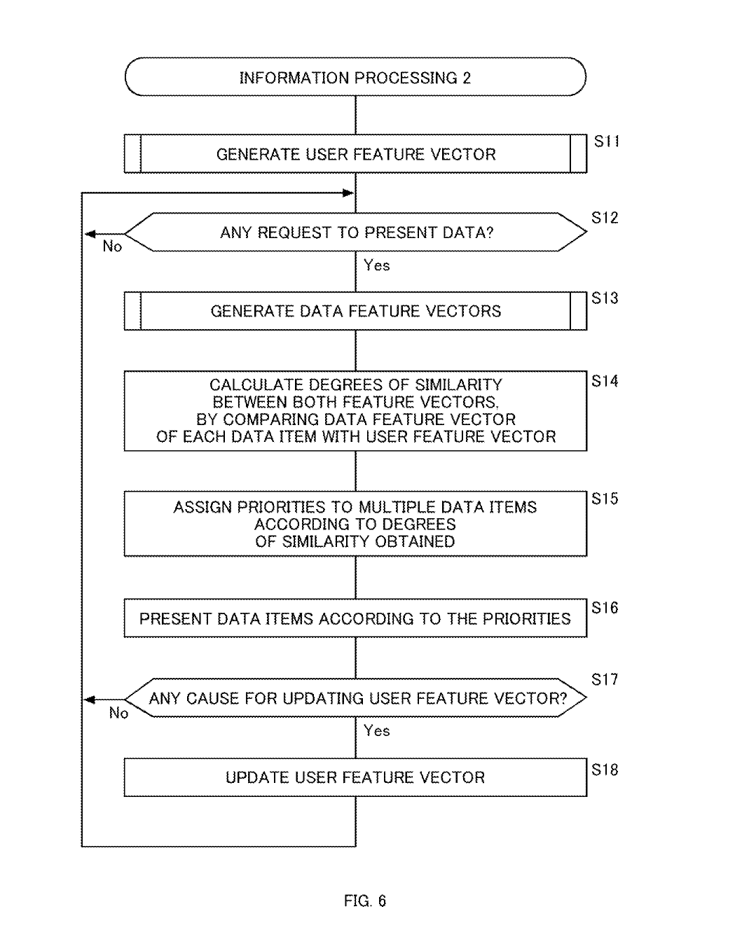

FIG. 6 illustrates a schematic procedure example of the information processing 2 in the present embodiment. In this embodiment, similar processing steps as those shown FIG. 5 are labeled the same, and the operations thereof shall not be tediously explained. In the processing of FIG. 6, steps S17 and S18 are added to the processing of FIG. 5.

In step S17, it is monitored whether or not there is any cause for updating the user feature vector. The cause of updating includes, for example, at least one of the following instructions; an explicit instruction from the user to display the entire document (full text) as to which a potion of the contents has been presented, an explicit instruction from the user expressing that the user likes the document being presented, an explicit instruction to perform printing, an instruction to post a remark, and an instruction to add a comment. In the present specification, the document that receives any of such instructions is referred to as “document of high interest”.

In step S18, the user feature vector is updated based on the operation by the user in step S17. In other words, when a new user feature vector is required based on a new document presented to the user, this new user feature vector and the immediately previous user feature vector are combined, thereby updating the user feature vector. Thereafter, the process proceeds with step S12.

Processing examples of steps S17 and S18 will be described specifically below. It is to be noted that in the information processing 2, the user feature vector is updated in step S18, and thus it is also possible to generate the initial user feature vector within this step. In that case, step S11 is not necessary.

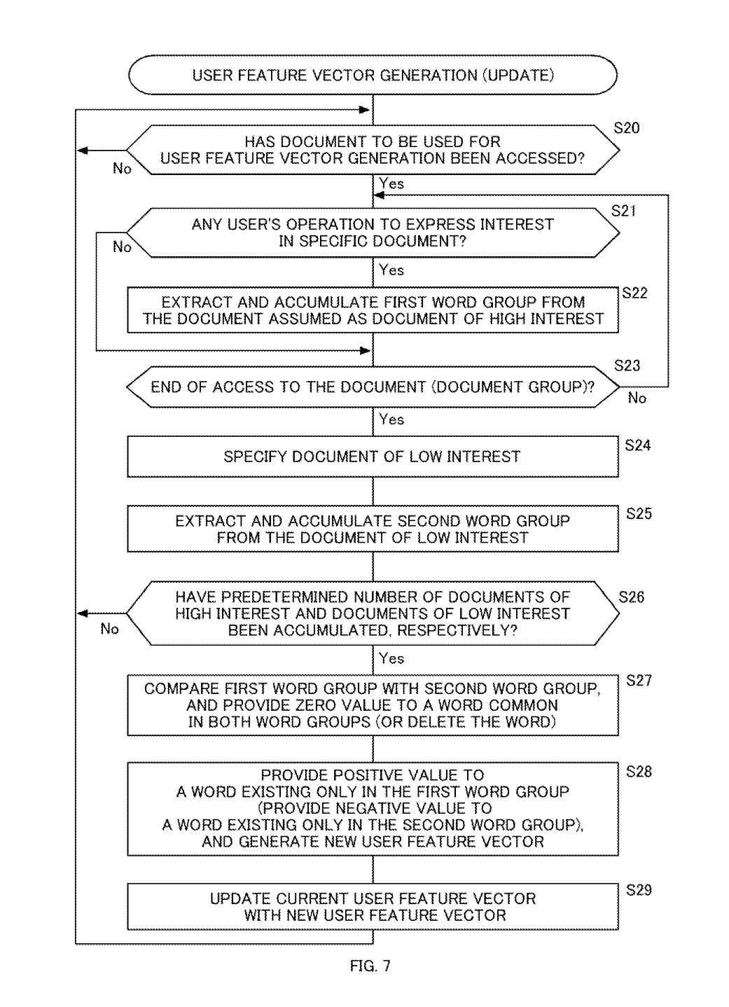

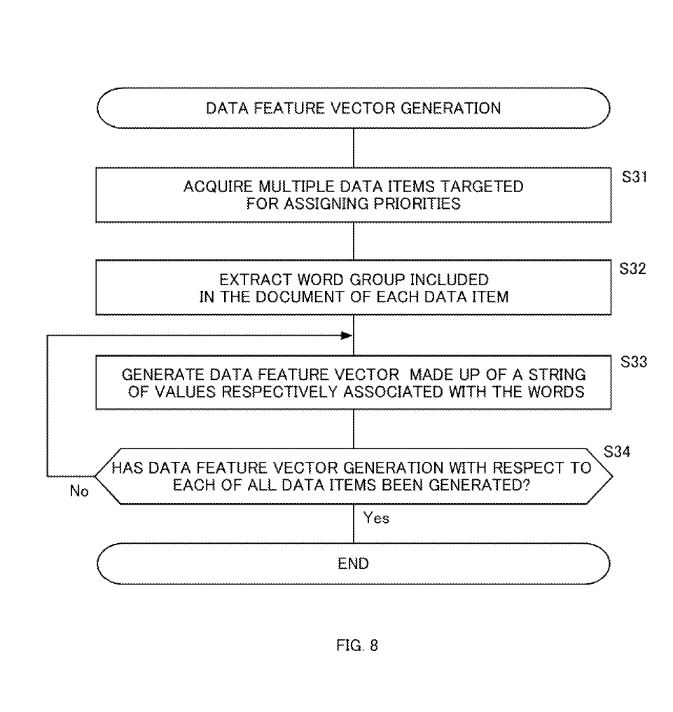

FIG. 7 illustrates a specific example of the processing procedure for generating (updating) the user feature vector as shown in steps S11 and S18. A process specific to the present invention as described below is employed in generating the user feature vector, so as to efficiently remove an unnecessary word without a load required for performing an advanced natural language processing such as the semantic analysis. FIG. 8 illustrates a specific example of the processing procedure for generating the data feature vector.

For the sake of explanatory convenience, the specific processing procedure for generating the data feature vector with reference to FIG. 8 will be explained before explaining the procedure for generating the user feature vector with reference to FIG. 7.

Firstly, multiple data items targeted for assigning priorities are acquired (S31). Here, the “multiple data items targeted for assigning priorities” are basically text data. However, data other than text data (e.g., a photo, a moving picture, music, or the like) may be targeted for assigning priorities, as far as any text data (document) is attached thereto. In the case where the data is a photo, a moving picture, music, or the like, the text being affixed is utilized as described above, and alternatively, the data may be converted to text data according to a method such as an image recognition method and an audio recognition method, so as to be converted to the data feature vector DVi.

Then, a word group included in the document in each data item is extracted (S32). An already-known method such as morphological analysis may be used for this extracting process. The morpheme is a minimum intelligible linguistic unit, and a typical morphological analysis separates a sentence into intelligible words, and determines a word class or its details by using a dictionary. In the present embodiment, the morphological analysis is performed only to the level of syntax analysis, but not the semantic analysis for analyzing the meaning of a word. With this configuration, it is possible to reduce processing load when a large amount of data is processed.

Subsequently, with regard to this word group, a data feature vector made up of a string of values respectively associated with the words is generated (S33). The “values respectively associated with the words” indicate, for example as described below, a numeral value “1” representing that there exists a word, or a fractional value (positive value) representing the frequency of word occurrence. An example of the fraction value representing the frequency of occurrence will be explained below. In the case where a vector is assumed with the dimension number exceeding the number of words included in one data item (the number of different words), the numerical value associated with the word not included in the data item is set to be “0”.

Step S33 is executed repeatedly as to all the multiple data items (S34).

Theoretically, the data feature vector can be expressed by n-dimensional vector Dvi representing all the things in the world, as the following formula, for example, according to aforementioned Example A. Here, represents an ordinal number (serial number) for discriminating multiple data items and data feature vectors:

DVi=[wi1,wi2, . . . , win]

Here, wi1, wi2, . . . , win represent n vector elements.

An example of the dimensional number n may be assumed as an approximate maximum number of words as to a certain language (e.g., n=approximately 100,000 words). Alternatively, it is possible to employ the number of almost all words that are utilized for library classification.

A function f is defined for mapping data Di to data feature vector DVi, in order to convert individual data items into data feature vectors:

DVi=f(Di)

By way of example, in the n-dimensional vector, the function f is defined in such a manner that if the m-th word (m=1, 2, . . . , n) out of n words occurs in the text of data Di, “wim” is set to be “1”, whereas if the m-th word does not occur, “wim” is set to be “0”.

It is also conceivable to define the function f in such a manner that wim is assumed as the frequency of occurrence of the m-th word in the text of data Di. By way of example, if it is assumed that the gross words extracted from the data Di is p, and the m-th word occurs q times, the frequency is expressed by q/p.

Next, in the process for generating (updating) a user feature vector as shown in FIG. 7, firstly, it is monitored whether or not there is any access to a document (document group) to be used for generating the user feature vector (S20). This access allows the document (document group) to be presented to the user.

If there is an access to the aforementioned document (document group), it is monitored thereafter, whether or not the user performs any operation indicating the user's interest to a particular document (S21).

If such operation is performed as described above, the document is configured as “document of high interest”, and a word group is extracted from that document (S22). The word group extracted from the document of high interest is referred to as a first word group.

The process returns to step S21, until the end of access to the document (document group) (S23). The end of access to the document (document group) corresponds to the case where accessing a different document (document group) is performed by the user's operation, or the application is terminated. The “accessing to a different document (group)” does not include jumping to an underlying layer by following a link set in the document (group).

After accessing the document (group) is completed, a document of low interest is specified (S24). The document of low interest is a document that has been presented to the user basically, but there has been no operation by the user, indicating user's interest in the document. By way of example, in the case where a user feature vector is generated in cooperation with a specific application such as SNS, a document of high interest is specified in response to the user's operation while executing the application, together with storing the document (full text) being presented. After the application is completed, it is possible to use, as the “document of low interest”, a document other than the document of high interest in the stored document. Upper limit may be provided for the number of documents of low interest that are specified in this step. The user feature vector being generated may be used to determine the order of priorities of the documents being presented, when the application is started next time.

It is to be noted that instead of using “the end of accessing” in step S23, the current clock time is referred to, and a document which is not subjected to the “operation indicating user's interest” is specified as the low interested document, after a lapse of a predetermined time from the current clock time. In step S20, it is also possible to refer to the current clock time, and collectively execute the subsequent processes after a lapse of a predetermined time. For that purpose, though not illustrated, the terminal, the server, or the like, for performing the processing above, are provided with a clock part (e.g., RTC) as a unit for managing the clock time and time period.

A word group is extracted also from the document of low interest (S25). The word group extracted from the document of low interest is referred to as “a second word group”.

Until a predetermined number of the documents of high interest and a predetermined number of the documents of low interest are accumulated, respectively, the process returns to step S20, and the processing above is executed repeatedly. The “predetermined number” here is a positive integer at least one, being determined in advance. The predetermined number of the documents of high interest is not necessarily equal to the predetermined number of the documents of low interest. The documents used for generating the user feature vector may be stored for a subsequent use. For that case, a full text of the document of high interest and that of the document of low interest may be stored respectively, or the word groups extracted from those documents, respectively, may be stored.

Thereafter, a comparison and contrast are performed between the first word group and the second word group so that a word common in both word groups is provided with a zero value (S27). This step corresponds to a process to set a value of the vector element associated with this word to “0”. However, in order to reduce the size of the vector and mitigate the processing load, it is alternatively possible to delete this word from the word groups. As a result of calculating the degree of similarity, setting a value of the vector element associated with a word to “0” is equivalent to deletion of the vector element. It is alternatively possible to determine the “predetermined number” based on the number of words, not by the number of documents.

Subsequently, a word existing only in the first word group is provided with a positive value, and a word existing only in the second word group is provided with a negative value, thereby generating a new user feature vector (S28). It is to be noted here that giving a negative value to the word existing only in the second word group is not absolutely necessary for the present invention.

Thereafter, the current user feature vector is updated with the new user feature vector (S29).

Specifically, for example, values of the words being the same between the past (old) user feature vector and the current (new) user feature vector are averaged (added together and divided by two). Alternatively, there may be a method to assign respective weights to the past value and the present value, other than half and half. By way of example,

(1) it is possible to define as the following:

¼ (past)+¾ (present)

This is suitable when a data item, whose changing pace is fast, is utilized, as in the case of SNS. The ratio between the past and the present is not necessarily limited to ¼ and ¾. Basically, it is possible to define as the following:

1/t (past)+(t−1)/t (present) (t=3, 4, . . . )

(2) The value of t in “1/t (past)+(t−1)/t (present)” is changed in such a manner that the value of t becomes larger in accordance with the length of time interval. Meaning of this definition is that if the longer time elapses, the past information becomes older, and therefore, a degree for referring to such older information is to be reduced. It is to be noted that if the documents of high interest and the documents of low interest from some past point of time until the present time are stored, and a new user feature vector is generated from those documents, it is possible to configure such that the old user feature vector is completely replaced by the new user feature vector being generated, without combining the user feature vector with the immediately previous user feature vector.

With updating the user feature vector as described above, a learning effect is expected, in which the user feature vector reflects the user's interests and tastes more effectively.

There is a possibility that the user accesses a single document instead of a group of documents, in other words, multiple documents (or titles) are not given in the form of a list. In this case, sometimes it is not possible to specify the document of low interest as against the document of high interest. In this situation, it is possible to use past documents of low interest being already accumulated.

Here, an explanation will be made as to the meaning of utilizing the document of low interest in addition to the document of high interest, in the present invention.

Here, it is assumed that a word not showing a distinctive feature is referred to as “noise”, in contrast to a word indicating a feature regarding the user's interests and tastes. It is conceivable that this noise varies depending on each user and changeable with time, as to a word other than general words (such as “I”, “today”, words of greetings, postpositional particles, and auxiliary verbs). When baseball game is taken as an example, if a user is strongly interested in a particular professional baseball team (e.g., Tigers), there is a possibility that the word “baseball” becomes noise for this user, but the word “Tigers” works as a feature word. As a method for removing noise, it is conceivable to set a reserved word corresponding to the noise. However, with this method, it is not possible to remove noise specific to each user so as to make the feature distinctive in the user feature vector. In addition, a word like a nonce word may become generalized with time, and thus it is difficult to set such word as the reserved word in advance.

Here, following examples are conceivable:

### Example 1

For the case of a user who is a big fan of a particular professional baseball team, examples of the word group occurring in the document of high interest are; baseball, pitcher, pre-season game, Tigers, Kakefu, Enatsu, Rokko-Oroshi, and so on. Examples of the word group occurring in the document of low interest are: baseball, pitcher, pre-season-game, Lions, Hara, Nagasima, Tokyo-Dome, and so on.

In those cases above, the words such as “baseball”, “pitcher”, and “pre-season-game” are included in both of the document of high interest and the document of low interest, and thus it is possible to determine that those words are noise. On the other hand, if the user is interested in baseball in all aspects, the words relating to baseball occur in the document of high interest, whereas the words relating to other than baseball occur in the document of low interest. Therefore, the words such as “baseball”, “pitcher”, and “pre-season-game” may not be noise but feature words.

### Example 2

For the case of a user who lives in Tokyo and shows a particular interest in neighboring surroundings of Takadanobaba, examples of the word group occurring in the document of high interest are: Tokyo, Yamanote-line, Toei-subways, Takadanobaba, Waseda, Seibu-line, and so on. Examples of the word group occurring in the document of low interest are: Tokyo, Yamanote-line, Toei-subways, Shinagwa, Ikebukuro, Osaka, Minato-ku, and so on.

In those cases above, the words such as “Tokyo”, “Yamanote-line”, and “Toei-subways” may be determined as noise. On the other hand, if the user is interested in Tokyo in all aspects, the words relating to Tokyo occur in the document of high interest, whereas the words relating to other than Tokyo occur in the document of low interest. Therefore, the words such as “Tokyo”, “Yamanote-line”, and “Toei-subways” may not be noise but feature words.

As discussed above, by using both the document of high interest and the document of low interest, it is possible to determine noise with respect to each user and remove the noise, not one-size-fits-all type noise that is determined as noise for all the users.

Hereinafter, operations of the present embodiment will be explained with simple and specific examples.

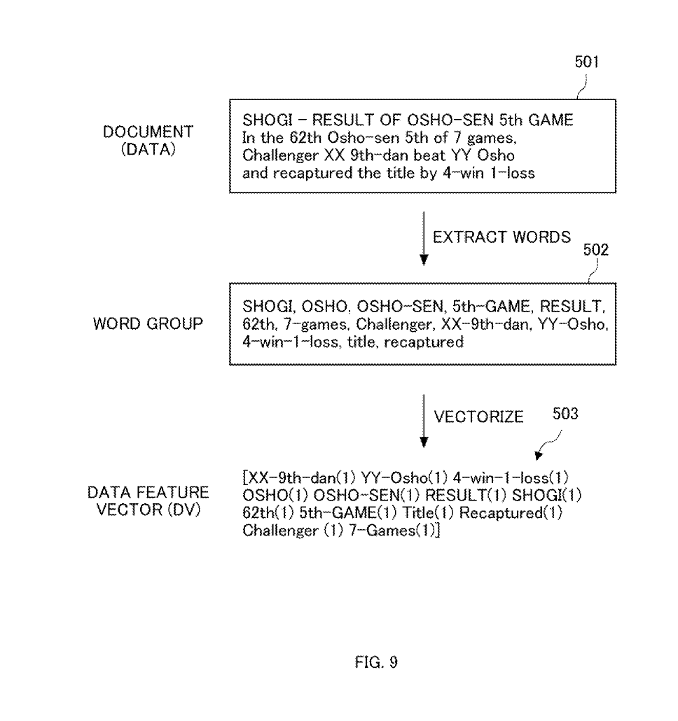

Firstly, with reference to FIG. 9, an example for generating a data feature vector will be explained. The document 501 as shown in FIG. 9 illustrates an example of news article presented to the user on the Internet. It is to be noted here that the data utilized for generating the data feature vector is not limited to news, but any documents including all kinds of text data presented to the user are applicable.

Words that occur in this document 501 are detected, and words being different from one another are extracted from the document 501 as shown in the word group 502. It should be noted that the present application is based on a Japanese application and a single word in Japanese could sometimes be interpreted into plural words in English, and hence, such plural English words are shown as a hyphenated compound word in this English specification and drawings. The data feature vector (DV) 503 is generated based on the word group 502. In this example, the data feature vector (DV) 503 is represented as a set of multiple pairs, each pair is made up of a word and a positive value (e.g., 1) indicating the word occurs in the document. In the figure, the pair is illustrated in the form of a word and a numeral value within parentheses following thereto, but any form is available. The dimension number (number of elements) of this data feature vector is determined based on the number of different words occurring in the document. By adding an element with the value “0”, it is possible to handle the data feature vector in a higher dimension. As described above, the data feature vector is construed at most, as n-dimensional vector at the highest, n corresponding to almost maximum number of words of a certain language. Here, the term “n-dimensional” is just a virtual term (e.g., n=approximately 100,000 words), and it is possible to determine a substantial dimension number n, only by the words actually occurred. (It is to be noted here that if two vectors are multiplied (obtain an inner product), the number of occurring word types increases (doubled at the maximum). If the number of targeted data items increases, the total number of the different words occurring in the data items also increases.

Currently, CPU throughput and CPU speed have been dramatically improved and capacity of storage has increased relatively, and therefore it is now possible to execute a high-dimensional vector computation in real time.

It is to be noted here that a method for extracting the word group in generating the data feature vector as illustrated in FIG. 9 is substantially the same as the method for extracting the “first word group” from the document of high interest in step S22 as shown in FIG. 7.

Next, an example for generating a user feature vector will be explained. Various documents may be available as the “document (document group) used for generating the user feature vector” in step S20 in FIG. 7 as described above. Basically, any text data accessible by the user on the Internet is applicable as the document.

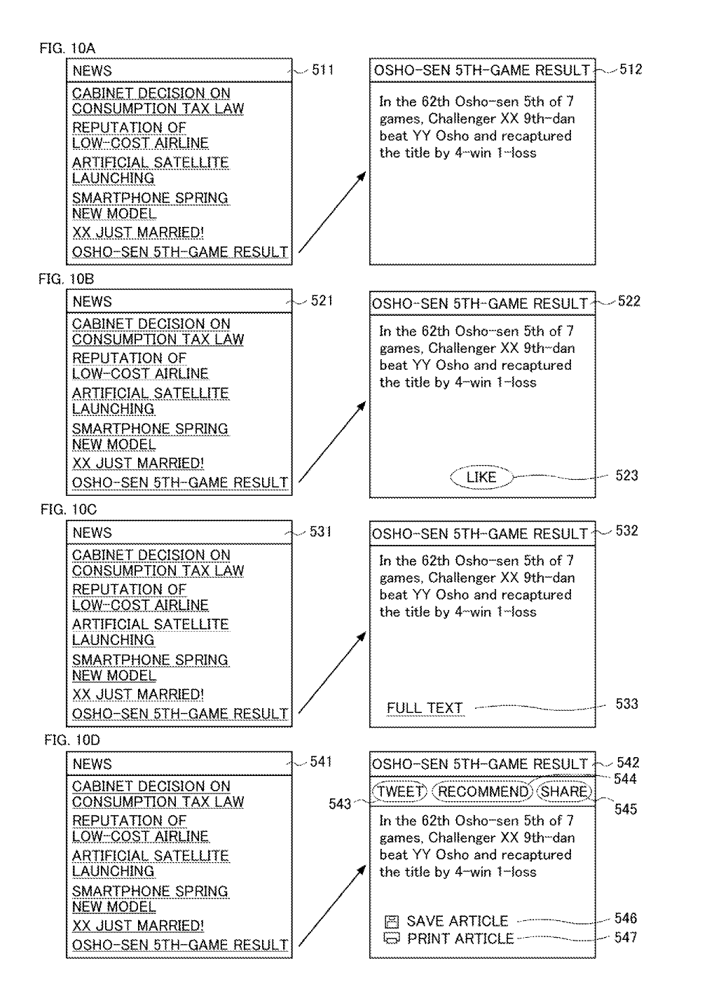

FIG. 10 illustrates an example of a screen (or a window: ditto in the following) showing news provided by a specific site on the Internet.

In the screen 511 of FIG. 10A, titles (or headings) of multiple articles provided as news are shown in the form of list (or summary). Each item (i.e., article) on the list is provided with a so-called link, and when the user points at a specific article, a screen 512 is newly displayed, indicating detailed descriptions of the article. Here, the “link” is a function that allows a user to jump to contents or the site indicated by a specific URL, when the user points at this position. According to this “user's explicit instruction to display the entire document as to which a portion of the contents has been presented”, the document is allowed to be recognized as a “document of high interest” in which the user is interested.

In addition, as shown in FIG. 10B, in the screen 522 after jumping from screen 521 (being the same as screen 511), there may be prepared a so-called “like” button, which corresponds to a display element 523 for allowing the user to perform “explicit instruction expressing that the user likes the document being presented”. It is also possible to recognize a document as the “document of high interest”, when the user gives the “explicit instruction to express that the user likes the document being presented”, such as the user's instruction with the “like” button, not only by displaying the entire document as the example of FIG. 10A.

As shown in FIG. 10C, in the screen 532 jumped from the screen 531 (being the same as the screen 511), a summary of the article may be shown together with a display element 533 for instructing a display of a full text of the article. According to this “user's explicit instruction to display the entire document as to which a portion of the contents has been presented”, when the user points at this display element, the document is allowed to be recognized as the “document of high interest” in which the user is interested.

As shown in FIG. 10D, in the screen 542 jumped from the screen 541 (being the same as the screen 511), there may be prepared on the screen, a “tweet” button, a “recommend” button, a “share button”, and the like, corresponding to the display elements 543, 544, and 545, respectively, each being selected by the user to allow the user who viewed this article to announce other user of the contents. It is possible to say that this instruction may be an explicit instruction from the user to reproduce the document being presented, but in broad sense, it is also conceivable that this is included in the “explicit instruction to express that the user likes the document being presented”. Therefore, it is possible to recognize the document that received such instruction as the “document of high interest” in which the user is interested.

Furthermore, display elements such as “Save article” and “Print article” as shown on the screen 542 may be prepared; a display element 546 for giving an “explicit instruction for saving the document”, and a display element 547 for giving an “explicit instruction for printing the document”, respectively. In response to pointing at those display elements by the user, it is possible to recognize the full-text document as the “document of high interest” in which the user is interested.

The article provided as the news is data presented to the user, and this data is utilized for generating the user feature vector, and also the data itself becomes “multiple data items targeted for assigning priorities”.

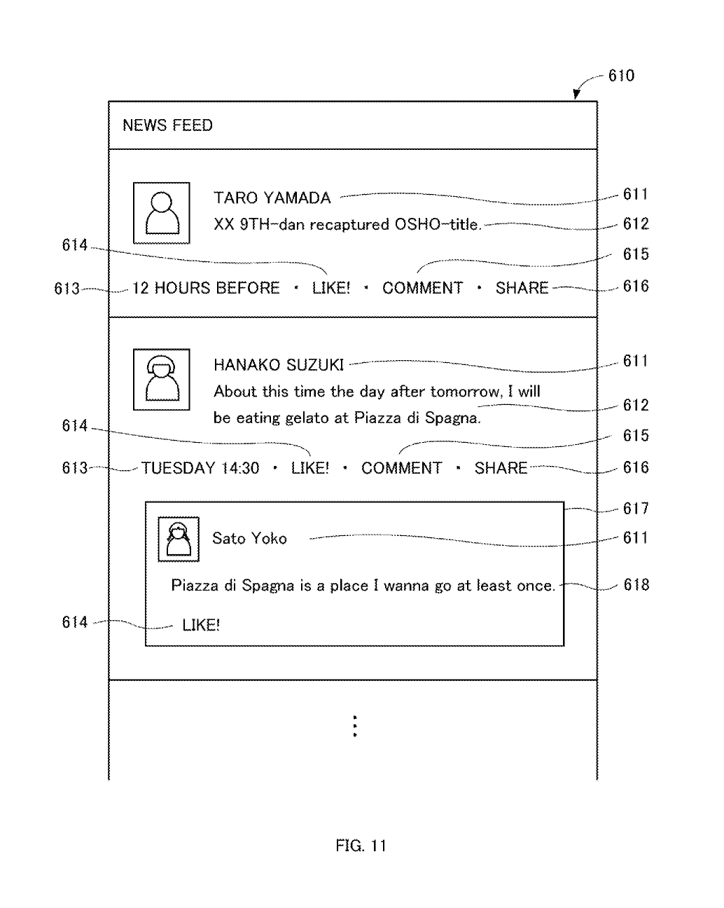

FIG. 11 illustrates an example of a display screen in a social networking service (SNS). This screen 610 corresponds to news feed screen that is a screen example referred to as “timeline”, displaying statements on a time-series basis, the statements being made by the SNS members (i.e., registered users) (e.g., users being set as friends of the user).

On the screen 610, multiple postings are displayed on a time-series basis, in such a manner that a new posting is sequentially displayed on the topmost. In each posting field, there are prepared a user ID 611 together with an image of a poster, a statement 612, posted date and time (or day of the week and clock time) 613, “Like” button 614, “Comment” button 615, and “Share” button 616. When a comment is inputted, the user ID 611 of the commenter and the comment contents 618 are displayed within the comment field 617. The “Like” button 614 is prepared also for the comment contents.

The statement 612 and the comment contents 618 on the screen 610 are documents created by specific users, and it is possible to determine that those documents are “document of high interest” in which the user is interested. Alternatively, when a second user points at the “Like” button 614, the “Comment” button 615, or the “Share” button 616 for any of the documents, it is possible to determine that the “second user” shows interest in the document. In response to such operation on any of those buttons, this document is also determined as the document of high interest for the “second user”.

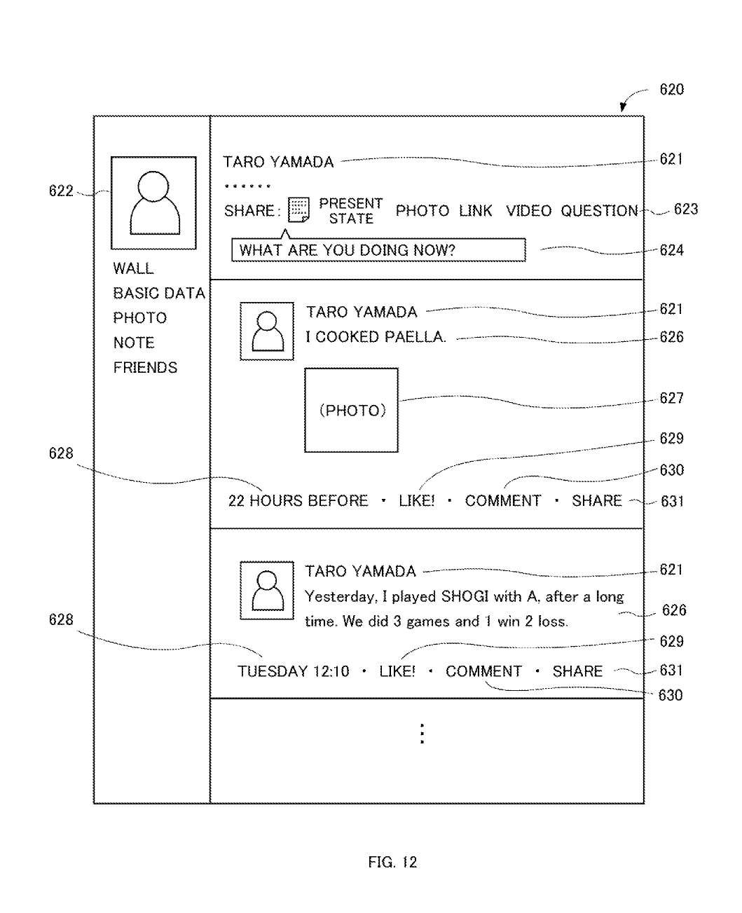

FIG. 12 shows one of other examples of the display screen in the SNS. This screen 620 is a screen of the user himself or herself, so-called “wall”, in which the user himself or herself (Taro Yamada, in this example) wrote a post in the SNS, and statements and the like, being posted, are displayed on a time-series basis. The image 622 of the user is shown on the upper-left of the screen. When the user indicated by the user ID 621 writes a post from the operation part 623 by using the posting input field 624, a new posting is incrementally added on the topmost of the posting display field on a time-series basis. In each posting display field, there are displayed the user ID 621, a statement 626 being posted, and a photograph or the like 627 being posted. In addition, if this statement is published, a second user may view it and the second user may express that he or she likes the statement by using the “Like” button 629, add a comment by using the “Comment” button 630, or share (copy) the statement by using the “Share” button 631, with respect to each statement. In response to the operations according to those buttons, it is possible to say that the document is a document of high interest for the “second user”.

The user himself or herself generated the statement 626 in the screen 620, and it is also determined as the “document of high interest” in which the user is interested. In addition, when the second user points at the “Like” button 629, the “Comment” button 630, or the “Share” button 631 for the document, it is determined that the second user is interested in the document.

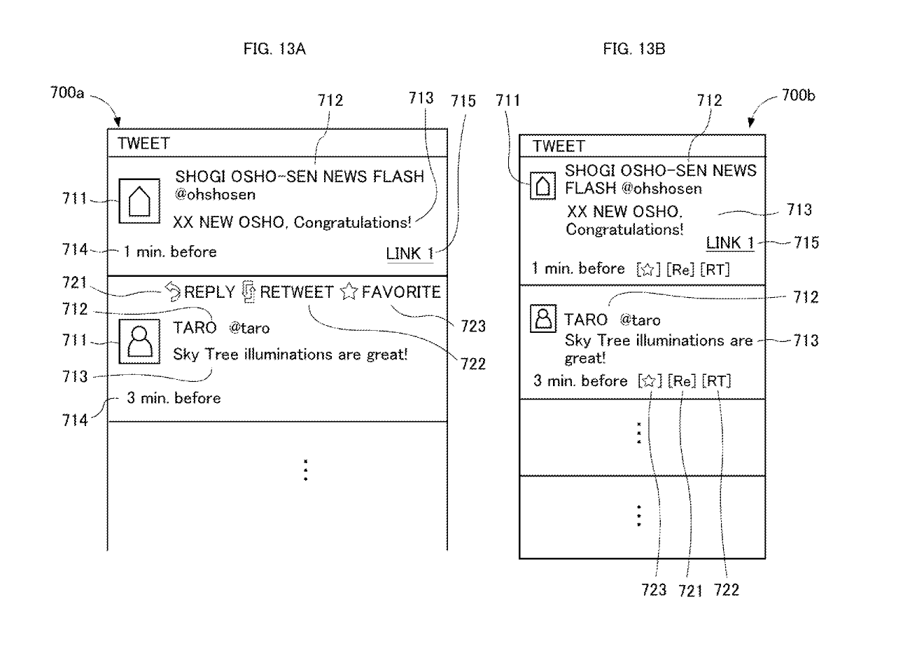

Next, Twitter (registered trademark) will be taken as an example of the “document (document group) used for generating the user feature vector”. FIG. 13A and FIG. 13B illustrate screen examples, respectively, on a PC for displaying a relatively large screen 700a, and on a portable terminal for displaying a relatively small screen 700b, and the contents posted are displayed on a time-series basis on Twitter (registered trademark).

Posted documents are listed on a time-series basis, and a newly posted document is incrementally added on the topmost. A display field of one posting (tweet) includes an image 711 of the user as a poster, the user ID 712, and posted contents 713. The posted contents may include a link 715 connecting to a site being designated. At least as to the posted contents being focused currently, display elements 721, 722, and 723 respectively indicating “Reply”, “Retweet”, and “Favorite” are displayed. The posted contents 713 correspond to the “document” of the present invention. It is determined that that user is interested in this document, based on the pointing operation by the user at any of the display elements 721, 722, and 723, or the pointing at the link 715. Therefore, it is possible to determine that the document is the “document of high interest”. By way of example, at the time when the screen 700a or 700b is closed, or after a lapse of a predetermined time from when the screen was open, it is possible to determine that the document of posting in which the user was not interested is the “document of low interest”. In the case where there are too many documents of low interest, it is not necessary to use all those documents as the documents of low interest. For example, only a predetermined number of documents of low interest may be collected and stored.

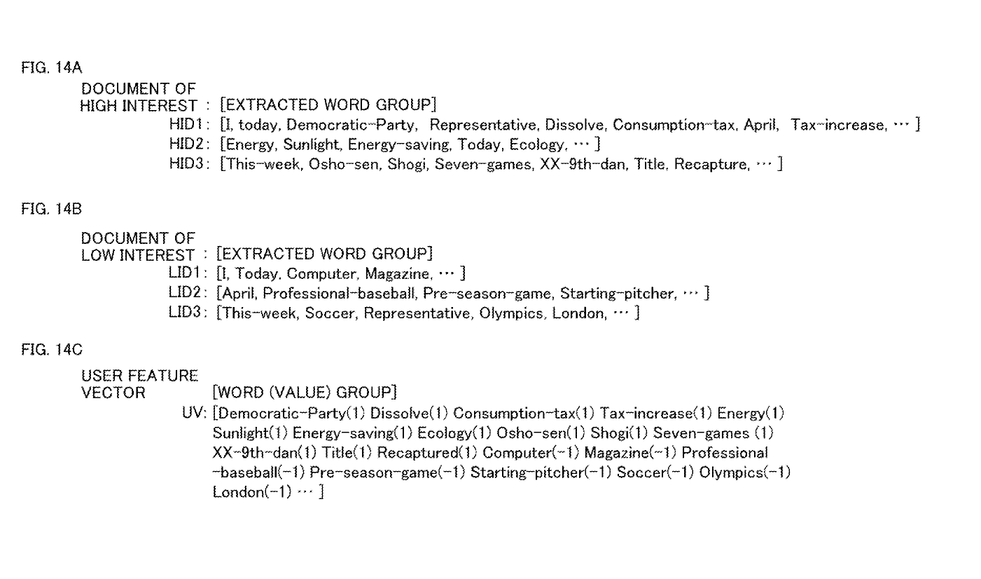

FIG. 14A, FIG. 14B, and FIG. 14C illustrate simplified examples, respectively, of the document of high interest and the document of low interest, specified from the group of documents, and the user feature vector. Here, following simplified specific examples are shown as the word groups extracted respectively from three documents of high interest; HID1, HID2, and HID3, and the word group extracted respectively from three documents of low interest LID1, LID2, and LIDS, in order to generate the user feature vector UV. (This extraction of the word group is just for the purpose of explanation, and this may be different from actually performed extraction.)

Word group in HID1: [I, today, Democratic-Party, Representative, Dissolve, Consumption-tax, April, Tax-increase, . . . ]
Word group in HID2: [Energy, Sunlight, Energy-saving, Today, Ecology, . . . ]
Word group in HID3: [This-week, Osho-sen, Shogi, Seven-games, XX-9^{th}-dan, Title, Recapture, . . . ]
Word group in LID1: [I, Today, Computer, Magazine, . . . ]
Word group in LID2: [April, Professional-baseball, Pre-season-game, Starting-pitcher, . . . ]
Word group in LID3: [This-week, Soccer, Representative, Olympics, London, . . . ]

The number of the documents of high interest and low interest used at once for generating the user feature vector is not limited to three for each. In this example, the user feature vector UV is obtained according to the following rules:

1) A word occurred only in the document of high interest is provided with a non-zero numeric value “1” as a weight value;

2) A word occurred only in the document of low interest is provided with a non-zero numeric value “−1” as a weight value having a reverse sign; and

3) A word occurred both in the document of high interest and in the document of low interest is provided with a numeric value “0” as a weight value.

As shown in FIG. 14A and FIG. 14B, if there are given word groups extracted from the three documents of high interest HID1, HID2, and HID3, and word groups extracted from the three documents of low interest LID1, LID2, and LID3, the user feature vector UV is created as the following as shown in FIG. 14C.

[Democratic Party(1) Dissolve(1) Consumption-tax(1) Tax-increase(1) Energy(1) Sunlight(1) Every-saving(1) Ecology(1) Osho-sen(1) Shogi(1) Seven-games(1) XX-9^{th}-dan(1) Title(1) Recapture(1) Computer(−1) Magazine(−1) Professional-baseball-game(−1) Pre-season-game(−1) Starting-pitcher(−1) Soccer(−1) Olympics(−1) London(−1) . . . ]

The user feature vector UV above is established, describing each of the individual vector elements in the form of pairs, each pair including a word and a value given to the word. If a value is give to each of all 100,000 words, the vector becomes 100,000-dimensional vector, but since almost all of the values of the words are zero, the vector is described using only the words whose values are not zero.

The user feature vector UV thus obtained is compared with the data feature vectors DV of multiple data items targeted for assigning priorities, thereby obtaining a degree of similarity between both feature vectors. Specifically, a product sum of weight values of the words associated with each other between both feature vectors is obtained as the degree of similarity. The “words associated with each other” indicates that those words are identical to each other. In the case where there is no associated word in the feature vector being the counterpart to be compared with, it is assumed that that word with a zero value exists in the counterpart feature vector. This processing is performed to make the dimension number of one feature vector identical to that of the other feature vector so as to calculate the inner product therebetween. In actuality, if a word included in the user feature vector having a positive value “1” is included in the data feature vector of the data targeted for processing, a product of the weight values between those words becomes a positive value (“1”). Therefore, the more are included in the data feature vector, the word identical to the word having the numerical value “1” in the user feature vector, the larger becomes the product sum of the weight values, and this enhances the degree of similarity between both feature vectors. On the other hand, if the word having the numerical value “−1” included in the user feature vector is included in the data feature vector of the data targeted for processing, the product of the weight values between the words becomes a negative value (“−1”). According to this process, the product sum of the weight values is subjected to subtraction, resulting in a reduction of the degree of similarity.

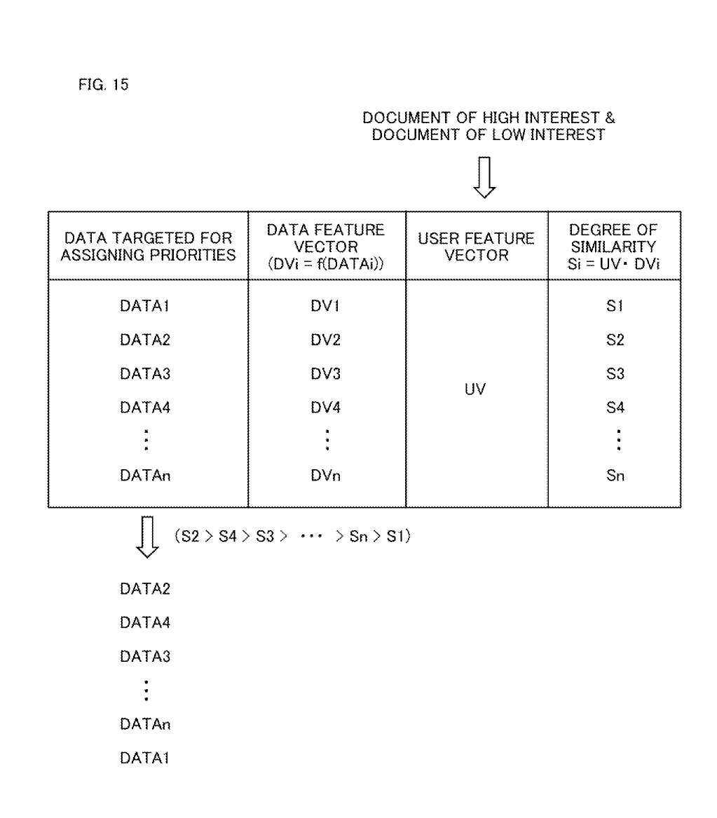

FIG. 15 illustrates how the priorities are assigned to multiple data items targeted for assigning priorities, based on the user feature vector in the present embodiment. In the example shown in the figure, when the data feature vectors of n data items DATA1 to DATAn are respectively DV1 to DVn, the degrees of similarity S1 to Sn are obtained as the product sum of the weight values of the words associated with each other between the user feature vector UV and each of the data feature vectors DVi, in other words, as a result of the inner product thereof (Si=UV·DVi). It is to be noted that the user feature vector UV is generated based on the document of high interest and the document of low interest as discussed above.

If it is assumed that there is a relation in the degrees of similarity, S2>S4>S3> . . . >Sn>S1, priorities are assigned to n DATA items in the order of DATA2, DATA4, DATA3, . . . DATAn, and DATA1.

In the example of FIG. 14, the absolute values of the positive value and negative value given to the words of the user feature vector are both assumed as the integer value “1”. Alternatively, it may be a real value. As one example similar to the case as described above, it is possible to define for data Di the frequency of a certain word occurrence in the document, as a value given to the word. By way of example, if it is assumed that the gross number of words extracted from a certain document is p and the m-th word occurs q times, the frequency is expressed by q/p. Setting a real value as the numerical value given to the word is meaningful, if it is possible to determine that the higher is the frequency of the same word occurrence in the same document, the higher is the user's interest in the word.

It is to be noted that even when an integer value is used as an element of the user feature vector, a value of the element after being updated as described above could not be an integer value.

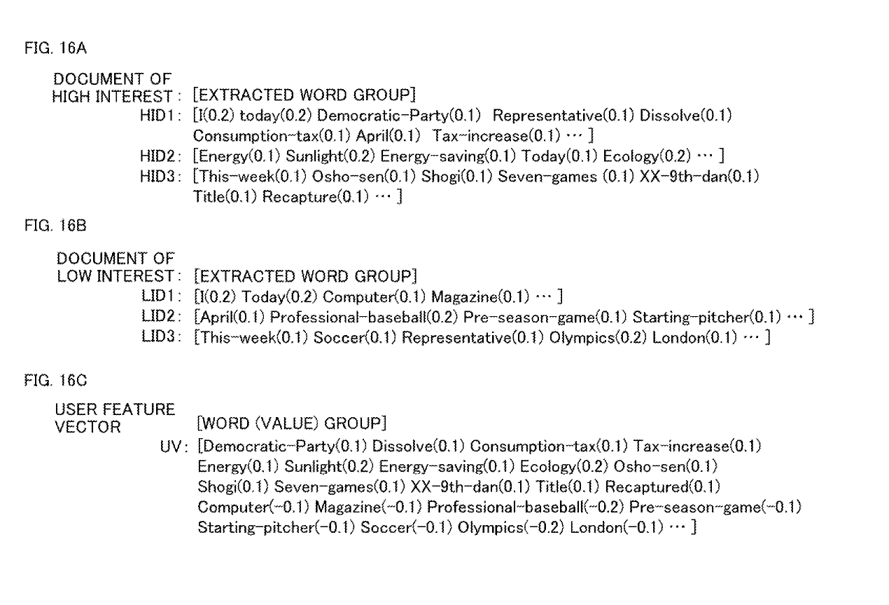

FIG. 16 shows an example for generating the user feature vector in the case where such real value is given to a word. FIG. 16A, FIG. 16B, and FIG. 16C are basically the same as FIG. 14A, FIG. 14B, and FIG. 14C. However, positive and negative real values are given to the word group extracted from the document, and therefore, the value of each word of the user feature vector obtained from the word groups also becomes a real value. In this point, the case of FIG. 16 is different from that of FIG. 14. The more words are included in the data feature vectors of the data targeted for processing, the word being identical to the word with the positive value included in the user feature vector, the larger becomes the product sum of the weight values, and accordingly the degree of similarity between both feature vectors is enhanced. On the other hand, if the word with a negative value included in the user feature vector is also included in the data feature vector of the data targeted for processing, a product of the weight values of those associated words become a negative value. Accordingly, the product sum of the weight values is subjected to subtraction, resulting in reduction of the degree of similarity. On this occasion, the words included in both the document of high interest and the document of low interest are provided with a value zero, or deleted, even though the real values thereof are different from each other.

For the case where the value given to the word is a real value, the method for assigning priorities to the multiple data items targeted for assigning priorities is also performed based on the user feature vector, in the same manner as the method explained with reference to FIG. 15.

The user feature vector as described above is generated based on the document of high interest and the document of low interest, but it is further possible to add user's profile data for generating the user feature vector. The user's profile data may be user's attribute information or private information, and it may include address, hobby, hometown, school one graduated from, and the like. By adding those words to the word group extracted from the document of high interest, it is possible to reflect the user's profile data on the user feature vector. However, there is a possibility that this reflection of the words of profile data on the user feature vector is diluted by updating the user feature vector as described above. In order to address this problem, it is conceivable that as for the word extracted from the profile data, a value of the vector element may be prevented from being affected by the updating. For that purpose, a pair of the word extracted from the profile data and a value given to the word is left as they are, upon updating the user feature vector, for instance.

The user feature vector based on the document of high interest and the document of low interest requires accessing by the user to a predetermined number of documents, and thus all the vector elements are set to “0” initially. Here, it is possible to configure such that the user is prompted to respond to questionnaires at the initial stage and a result of the questionnaires is quantified, thereby generating an initial-stage user feature vector. As an example of the questionnaires, keywords are prepared in advance, allowing the user to set a degree of user's interest to each keyword (e.g., rated on a scale of multiple numerical values).

On the basis of the initial-stage user feature vector obtained according to the procedure above, it is possible to assign priorities on data items on the initial state. It is to be noted that making use of the user's profile data is not indispensable in the present invention.

Next, a modification example of the present embodiment will be explained. In the explanations above, the user feature vector is used as information for representing the user's feature. However, it is also possible to extend the user feature vector to a tensor. In other words, since a vector may be interpreted as a first order tensor, the feature vector may be extended to a feature tensor (second order, third order, and so on). In the present modification example, the user feature information is converted to a second-order user feature tensor. A predetermined operation is performed between the user feature tensor and the data feature vector, so as to obtain real numbers (all ordinal numbers) representing the degree of similarity therebetween.

In this modification example, as for the data, a data feature vector is generated based on occurring words, in the similar manner as the case above.

More specifically, as for the user feature tensor, documents are classified into the document of high interest and the document of low interest, among multiple documents, the contents of each document being presented at least partially to the user. Thereafter, word pairs commonly included in both one of the documents of high interest and one of the documents of low interest, respectively, are removed as noise. Then in the present embodiment, the user feature information is represented by a second order tensor (or matrix). Next, the user feature tensor is generated from the document of high interest and the document of low interest.

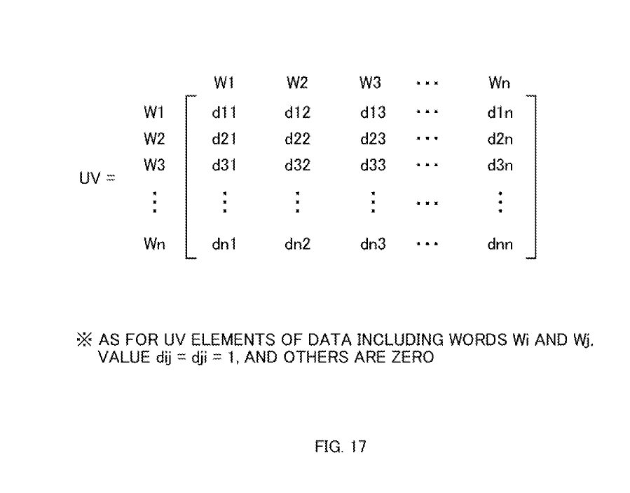

FIG. 17 shows a configuration example of the second-order user feature tensor. For the sake of convenience, the user feature tensor is also labeled as “UV”. In the case where the number of the words is n, a matrix with n rows and n columns represents the second-order tensor. A value of the tensor element, i.e., the matrix element is determined as the following.

Byway of example, for the word pair Wi, Wj included only in the document of high interest, it is assumed that values of the tensor elements (i, j) and (j, i) are dij=dji=1. For the word pair Wi, Wj included only in the document of low interest, it is assumed that values of the tensor elements (i, j) and (j, i) are dij=dji=−1. For the remaining word pairs, the value is assumed as 0.

When the second-order tensor (matrix) is used, a calculation formula: A(n×n matrix)×DV(n-dimensional vector)=B (n-dimensional vector) is used, for instance, instead of the inner product between the vectors, in order to calculate the degree of similarity. On this occasion, the degree of similarity may be defined as a function that establishes correspondence with real values (totally-ordered set) that represent strength of vector B, in other words, a sum of the elements, for instance. By way of example, in the case where B=[00110], the value of the degree of similarity becomes “2”, obtained by simply adding up the values of all the elements.

For example, upon generating a user feature vector, there is a high possibility that a document including the word “figure” may become the document of high interest for a person who is interested in skating. However, this could result in that an article relating to “a figure of a character” is also included as data having a high degree of similarity, in the user feature vector that is generated based on the document of high interest. In other words, this article is determined as data having high priority, failing in assigning priorities on the data items in appropriate manner according to the user's interests. The user feature tensor is able to solve this problem.

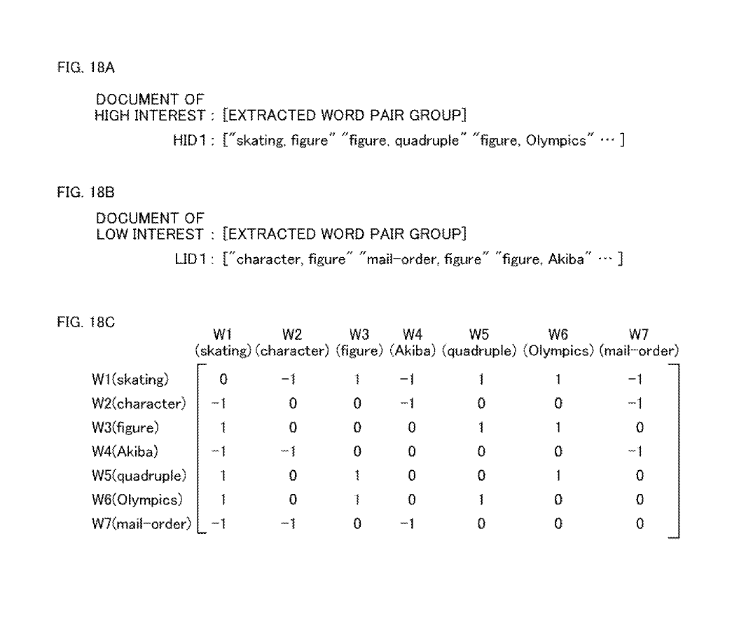

With reference to FIG. 18, a specific example for generating the user feature tensor will be explained.

For a user who is interested in skating, a document with occurring words such as “skating”, “figure”, “quadruple”, and “Olympics”, may become the document of high interest. As shown in FIG. 18A, all pairs of those words extracted from the document of high interest are made in the form of word pairs, such as “skating, figure”, “figure, quadruple”, and “figure, Olympics”. On the other hand, for this user, even though the word “figure” occurs, a document with occurring words such as “character”, “figure”, “mail-order”, and “Akiba”, etc. may become the document of low interest. On this occasion, as shown in FIG. 18B, all pairs of those words extracted from the document of low interest are made in the form of word pairs, such as “character, figure”, “mail-order, figure”, and “figure, Akiba”. The feature tensor in this case is expressed in the form of matrix as shown in FIG. 18C. If the total number of different words in each of both documents is “s”, the matrix becomes s×s.

It is to be noted that, though not illustrated, values of the tensor elements may not be integer values, but real number values on which frequency of occurrence, and the like, is reflected as discussed above.

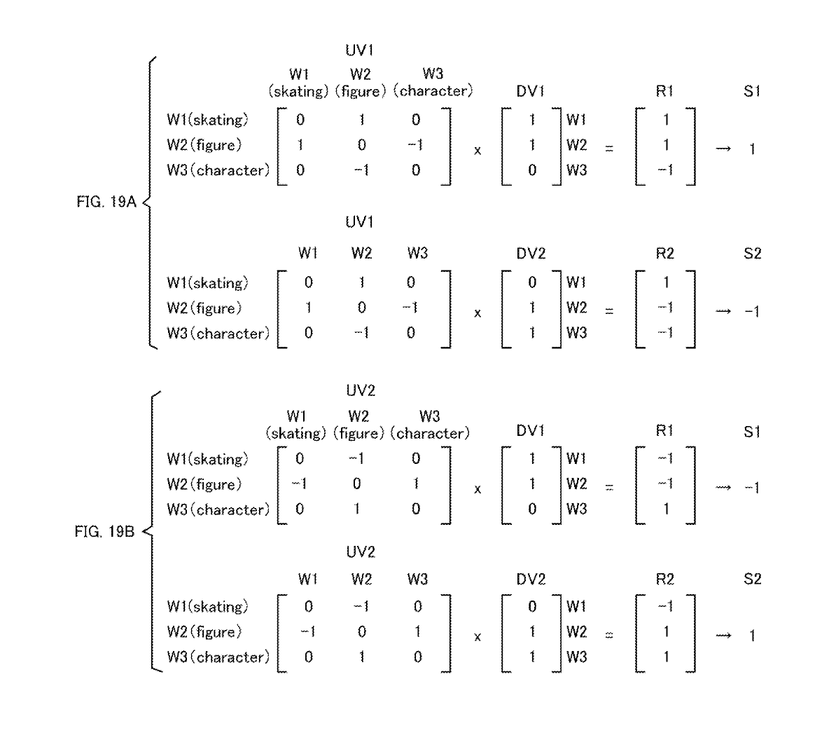

FIG. 19 illustrates an example for calculating the degree of similarity, by using the matrix of 3×3 as a subset of the matrix as shown in FIG. 18C, including “skating”, “figure”, and “character” as three words W1, W2, and W3 which are extremely simplified.

FIG. 19A illustrates how the degree of similarity varies in the case where the user feature tensor UV1 for the user who is interested in skating is compared with the data feature vectors DV1 and DV2 of two data items. It is assumed that the words “skating” and “figure” occur in the first data. In this case, the vector elements of the word pair corresponding to those words are set to “1” in the data feature vector DV1. It is assumed that the words “figure” and “character” occur in the second data. In this case, the vector elements of the word pair corresponding to those words are set to “1” in the data feature vector DV2. As a result, the elements of the vectors R1 and R2 (each being a matrix with 3 rows and 1 column), obtained by multiplying the user feature tensor by the first data feature vector and the second data feature vector, respectively, become (1, 1, −1) and (1, −1, −1). Therefore, the degree of similarity of the first data and that of the second data are S1=1+1−1=1, and S2=1−1−1=−1, respectively. Consequently, the result is S1>S2, and thus for this user, the first data takes precedence over the second data.

On the other hand, FIG. 19B illustrates how the degree of similarity varies in the case where the user feature tensor UV2 for the user who is interested in a character is compared with the data feature vectors DV1 and DV2 of two data items being identical to the example above. In the example of this figure, UV2 is a matrix being the same as the matrix of UV1 except that all the signs are inverted. The elements of the vectors R1 and R2 (each being a matrix with 3 rows and 1 column), obtained by multiplying the user feature tensor by the first data feature vector and the second data feature vector, respectively, become (−1, −1, 1) and (−1, 1, 1). Therefore, the degree of similarity of the first data and that of the second data are S1=−1−1+1=−1, and S2=−1+1+1=1, respectively. Consequently, the result is S1<S2, and thus for this user, the second data takes precedence over the first data.

As thus described, the word pair relating to skating (the words exist in the same document) occur in the document of high interest, and such pair is not found in the document of low interest. With this configuration, even though a certain word occurs in a document, it is not determined whether the document becomes the document of high interest or the document of low interest, by the existence of the word only, but it is determined according to a combination of the word and a second word. Therefore, it is possible to determine whether the word is noise or not, in units of word pair.

Similar to the aforementioned user feature vector, in order to generate the user feature tensor, both the document of high interest and the document of low interest are used, and the word pair occurring commonly in both documents is assumed as noise to be deleted, thereby reducing the size of the matrix and mitigating processing load.

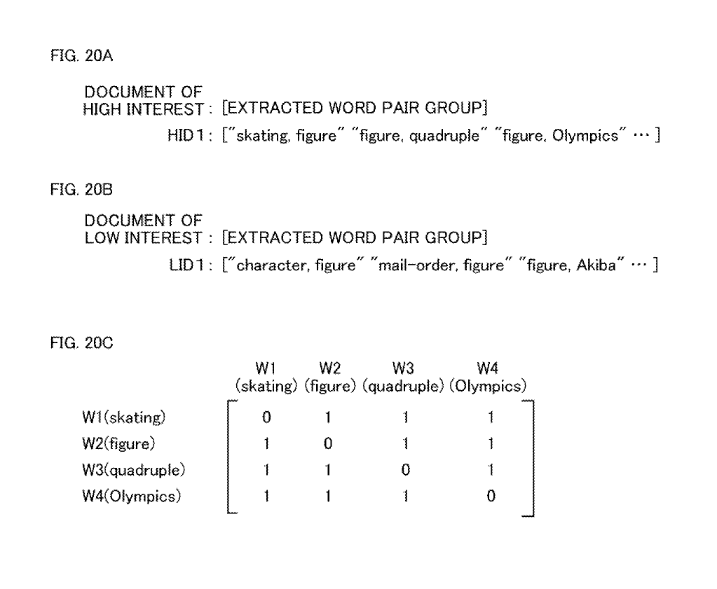

With reference to FIG. 20, a modification example for generating the user feature tensor will be explained.

As shown in FIG. 18A and FIG. 18B, when the word pairs for each of the document of high interest and the document of low interest are obtained, a negative value is given to each element of the word pair which occur only in the document of low interest in the aforementioned example. Alternatively, it is possible to provide “0” to the value of the matrix elements of the word pair occurring only in the document of low interest, or delete the word pair. In the example shown in FIG. 20C, the matrix elements of such word pairs are deleted. In a result of calculation to obtain the degree of similarity, providing “0” to the value of matrix elements of the word pair is equivalent to deletion of the matrix elements.

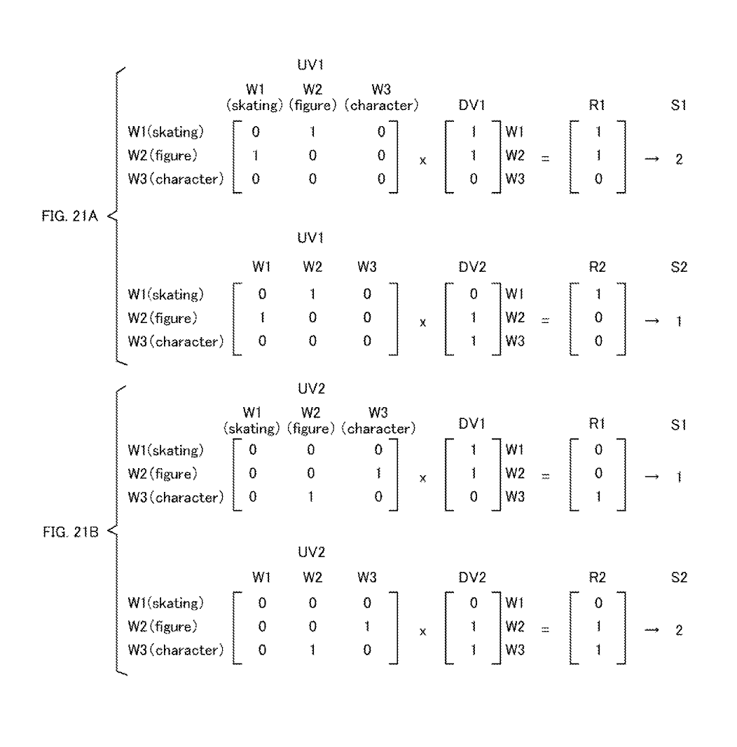

FIG. 21 illustrates an example for calculating the degree of similarity as to the user feature tensor of 3×3 matrix in association with the modification of the example of FIG. 20. Unlike the example shown in FIG. 19, the element values in the user feature tensor UV1 are different from those in UV2, and accordingly, values in the vectors R1 and R2, and values in the degree of similarity S1 and S2 are different from each other, respectively. However, for the first user, the calculation result becomes S1>S2, and thus similar to the example of FIG. 19, the first data takes precedence over the second data for this user. On the other hand, for the second user, the calculation result becomes S1<S2, and thus similar to the example of FIG. 19, the second data takes precedence over the first data for this user.

In the example for applying the present embodiment to the service server 300, the service server 300 crawls the information on the Internet, spontaneously, periodically, or in response to a user's request, acquires data items from the Internet, such as a document, a photograph, and a moving picture (with available text data), collects data appropriate for interests and tastes of each user (registered user), assigns priorities thereto, selects data with high priority (or in the order of priority) to transmit the data to the user's terminal to present the data to the user. The information on the Internet includes any type of information such as news, posting, advertisement, book information, corporate information, and music information.

According to the present invention, it is possible to implement processing that is appropriate for the user's interests and tastes, in corporate with any type of equipment at home or on a street corner, in addition to being applied to the service in the service server 300. Various equipment may be taken as examples thereof, such as a portable terminal, a household electrical appliance, a gaming machine, and a robot.

In the explanation as described above, the document of high interest is a document that has received at least one of the following instructions; an explicit instruction from the user to display the entire document as to which a part of the contents has been presented, an explicit instruction to express that the user likes the presented document, an explicit instruction for saving the document, and an explicit instruction for printing the document. In addition, a document posted by the user, a document to which the user provides a comment, and a document of the user's comment itself are also defined as the document of high interest. In the example as shown in FIG. 14, those documents of high interest are treated equivalently. On the other hand, it is further possible to differentiate those instructions and documents of various types. By way of example, it is assumed that in many cases, a degree of the user's interest is higher in the explicit instruction to express that the user likes the presented document, than the degree of interest in the explicit instruction from the user to display the entire document. Also it is needless to say that a document posted by the user, a document in which the user provides a comment, or the like, may represent the user's high interests. Therefore, as for this kind of particular document which has received an explicit instruction expressing that the user likes the document, or a posted document, a comment document (a document to which the comment is provided or the comment itself), words extracted therefrom may be provided with a value larger than the value for the documents that received other instructions. In addition, the value to be provided may vary depending on the type of instructions, stepwise at least three steps.

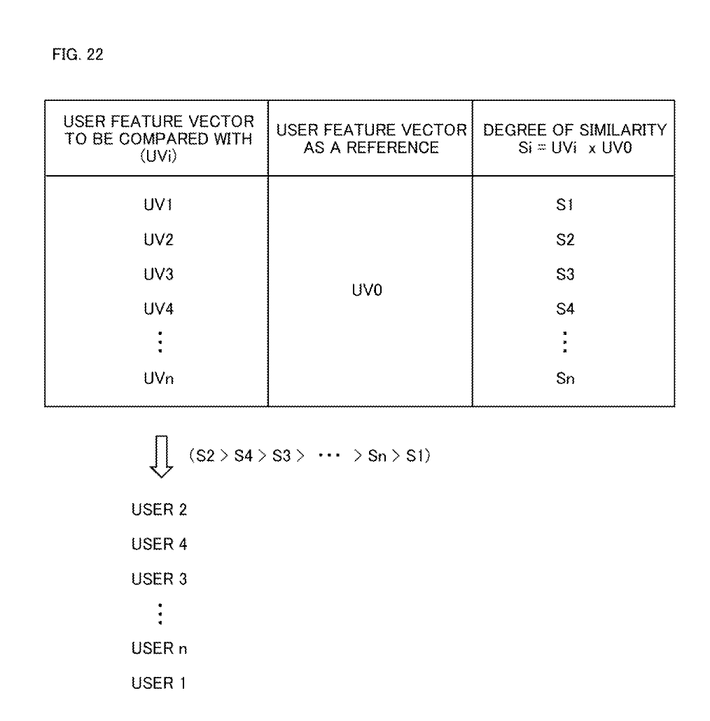

Next, with reference to FIG. 22, a second modification example of the present embodiment will be explained. In this modification example, a degree of similarity (i.e., distance) is calculated between the user feature vectors (or tensors) among a plurality of users, thereby obtaining a degree of affinity between the users.

As shown in FIG. 22, a user feature vector of a specific user is assumed as a reference user feature vector UV0, and a degree of similarity Si=UVi·UV0 is calculated using a user feature vector UVi as a target. In other words, the degree of similarity between the user feature vectors may be calculated by obtaining an inner product between one user feature vector and a second user feature vector. It is to be noted here that the calculation for obtaining the degree of similarity in the present invention is not limited to the inner product, in any of the calculations for obtaining the degree of similarity; between the user feature vectors, and between the user feature vector and the data feature vector as discussed above. Taking as an example the degree of similarity between the user feature vectors, it may be generalized as the function Si=s(UVi, UV0) which establishes association with a real number. By way of example, a coefficient of correlation or Euclidean distance between the vectors may be applicable. In addition, a definition s(UVi, UV0)=(UVi·UV0)/|UVi| may also be conceivable. Though not illustrated, it is further possible to obtain a degree of similarity between the user feature tensors. In other words, the degree of similarity between the user feature tensors may be obtained by calculating a distance between one user feature tensor and the other feature tensor, as expressed in the following formula:

$$\sqrt{ } \{ {\sum }_{i , j} {( aij - bij )}^{2} \}$$

Here, aᵢⱼ represents a tensor element of the first user feature tensor, and bij represents a tensor element of the second user feature tensor. In other words, this formula expresses the square root of the square sum of differences between the same elements of i row and j column.

The degree of similarity obtained by comparing between the user feature vectors (or tensors) may be used as an index indicating the degree of affinity between users. In the example of FIG. 22, priorities are assigned to the users to be compared, based on the degree of similarity Si being calculated (in descending order).

The feature of the present invention for obtaining the degree of affinity between users by using the user feature vectors as explained in FIG. 22 may be established independently of the above-described processing using the data feature vector.

Next, a modification example of the aforementioned degree of similarity will be explained. As the degree of similarity, the inner product between each of the data feature vectors of the data items targeted for assigning priorities, and the user feature vector is obtained, in other words, a sum of product between the weight values of the words being associated in both feature vectors is obtained. On the other hand, in the present modification example, the degree of similarity thus obtained is corrected according to a predetermined condition, as the following:

Degree of similarity=Inner product (Data feature vector, User feature vector)×Entropy

Here, the term “Entropy” indicates information entropy, which corresponds to an amount of information of each data item. The data feature vector of each data item is a vector having a value of occurrence probability of a word in a document, and the information entropy represents an “information amount wise” scale, which is held by the vector. If judgment of an article is made only based on the original inner product value, without correcting the inner product with this kind of information amount value, an article being shorter in text is more advantageous. This is because, the shorter is the text, the less words are included, and the occurrence probability of one word seems to become higher. In order to correct this defect, this modification example multiples the inner product value by the information entropy that is held by the article. As a result, the longer is the text of the article, the value of entropy becomes larger, and it is possible to correct the original degree of similarity to a larger value. The information entropy of the document D is expressed by the following formula:

E=−Σp log p

Here, p represents the occurrence probability of each word in the feature vector of the document D. By way of example, the information entropy as to some feature vectors cvec is calculated as the following:

If cvec1={(curry, ½) (India, ½)},

E=−1/2 log(1/2)−1/2 log(1/2)=1

If cvec2={(curry, ¼) (India, ¼), (cooking, ¼), (Hot, ¼)},

E=2

If cvec3={(curry, ⅛), . . . all ⅛},

E=3

In order to mitigate the calculation amount, the following formula may be employed as the approximation of the entropy:

E=log(vector length)

In the example above,

cvec1=log(2)=1

cvec2=log(4)=2

cvec3=log(8)=3

The value of the approximation formula agrees with the entropy value, when the occurrence frequency of each word in the vector is equivalent. Here, the base of log is 2. Instead, the base may be “e (Napier's constant)”. Both logarithmic values are different only by a constant factor, and there is no impact on a result of processing in the present embodiment.

Here, in the multiple data items targeted for assigning priorities, there may exist totally identical documents or documents substantially the same with a common source. It is wasteful to present the user those substantially the same documents redundantly. Therefore, it is desirable to perform redundancy check among those multiple data items. This redundancy check may be implemented by obtaining a degree of similarity between the data feature vectors of multiple data items, by calculation using a correlation coefficient. The degree of similarity between the two data feature vectors a and b is expressed by the following formula:

Similarity=(a·b)/(|a∥b|)

It is to be noted here that the method for calculating the degree of similarity regarding multiple data feature vectors is not limited to the formula above. By way of example, it is also possible to use the Euclidean distance between the vectors.

The preferred embodiment of the present invention has been explained so far, and it is further possible to perform various modifications and apply changes, in addition to those described above. By way of example, it is not absolutely required to include a negative value in the elements of the user feature vector (tensor). The above explanation has been made assuming the language of the document is Japanese, but any other language is applicable. The “explicit instruction by the user” may not be limited to the instruction to a displayed element such as a button, but include an instruction by selecting an item from a menu (in any form such as pull-down and pop-up). The “instruction” may be a touch instruction by the user on a touch panel, in addition to the instruction by a pointing device such as a mouse.

The present invention includes a computer program that allows a computer to implement the functions as explained in the aforementioned embodiment, and a recording medium that stores the program in a computer readable manner. As the “recording medium” for supplying the programs may be, for example, a magnetic recording medium (flexible disk, hard disk, magnetic tape, or the like), an optical disk (magnetic optical disk such as MO and PD, CD, DVD, or the like), semiconductor storage, and the like.

What is claimed is:

1. An information processing method in an information processing apparatus, comprising the steps of:
generating a user feature vector specific to a user;
extracting a word group included in each of multiple data items targeted for assigning priorities and generating a data feature vector specific to each data item, based on the word group extracted;
obtaining a degree of similarity between each of the data feature vectors of the multiple data items and the user feature vector; and
assigning priorities to the multiple data items to be presented to the user, according to the degree of similarity obtained;
the step of generating the user feature vector including a step of specifying a document of high interest in which a user expresses interest and a document of low interest in which the user expresses no interest, according to the user's operation among multiple documents presented to the user, a word group included in the document of high interest and a word group included in the document of low interest being compared with each other, a weight value of a word included commonly in both documents being set to zero, the weight value of a word included only in the document of high interest being set to a non-zero value, and a string of the weight values in association with the word groups being generated as the user feature vector.

2. The information processing method according to claim 1, wherein,
in the step of obtaining the degree of similarity, each of the data feature vectors of the multiple data items targeted for assigning priorities and the user feature vector are compared with each other, and a product sum of the weight values of the words being associated with each other between the data feature vector and the user feature vector, is obtained as the degree of similarity.

3. The information processing method according to claim 1, wherein,
in the step of generating the user feature vector, a word group included only in the document of low interest is extracted, the weight values different in signs are added, respectively to the word included only in the document of high interest and to the word included only in the document of low interest, and the weight values of the words are combined, thereby obtaining the user feature vector.

4. The information processing method according to claim 1, wherein,
the document of high interest is a document receiving at least one of following instructions, an explicit instruction from the user to display the document entirely as to which a part of contents is already presented, an explicit instruction to express that the user likes the document being presented, an explicit instruction for saving the document, and an explicit instruction for printing the document; or at least one of following documents, a document posted by the user, a document to which the user provides a comment, and a document of the user's comment.

5. The information processing method according to claim 1, wherein,
the document of low interest is at least one document in which the user expresses no interest, out of the multiple documents, when the multiple documents are presented all at once.

6. The information processing method according to claim 1, wherein,
the document of low interest is stored, and if a document becomes the document of high interest and no document of low interest is newly specified, the document of low interest being stored is used for generating the user feature vector.

7. The information processing method according to claim 1, further comprising a step of updating the user feature vector, upon obtaining a new user feature vector based on a new document presented to the user, by combining the new user feature vector with the user feature vector.

8. The information processing method according to claim 1, further comprising a step of reflecting the profile data of the user on the user feature vector by adding a word extracted from profile data of the user, to the word group extracted from the document of high interest.

9. The information processing method according to claim 8, wherein,
as for the word extracted from the profile data, an element value of the user feature vector is prevented from being affected by the updating.

10. The information processing method according to claim 1, further comprising,
a step of comparing the user feature vector of a user as a reference, with each of the user feature vectors of multiple other users, and obtaining a degree of similarity between the user feature vectors; and
a step of assigning priorities to the multiple other users with respect to the user as the reference, according to the degree of similarity.

11. The information processing method according to claim 1, wherein,
in the step for generating the user feature vector, different word pairs included in one document are extracted with respect to each document, and a user feature tensor including the word pairs is obtained instead of the user feature vector, and
in the step for obtaining the degree of similarity, vector magnitude obtained as a product of the user feature tensor and each of the data feature vectors of the multiple data items targeted for assigning priorities is assumed as a degree of similarity between the data feature vector and the user feature tensor.

12. The information processing method according to claim 2, further comprising a step of correcting the degree of similarity based on an amount of information of the data item, after obtaining as the degree of similarity, the product sum of the weight values of the words being associated with each other between the data feature vector and the user feature vector.

13. The information processing method according to claim 1, further comprising a step of obtaining the degree of similarity between the data feature vectors among the multiple data items, thereby performing redundancy checking of the data items and deleting redundant data items.

14. An information processing apparatus comprising,
a generating unit for generating a user feature vector specific to a user;
an extracting unit for extracting a word group included in each of multiple data items targeted for assigning priorities and generating a data feature vector specific to each data item based on the word group extracted;
an obtaining unit for obtaining a degree of similarity between each of the data feature vectors of the multiple data items and the user feature vector; and
an assigning unit for assigning priorities to the multiple data items to be presented to the user, according to the degree of similarity obtained;
the generating unit for generating the user feature vector specifying a document of high interest in which a user expresses interest and a document of low interest in which the user expresses no interest, according to the user's operation among multiple documents presented to the user, a word group included in the document of high interest and a word group included in the document of low interest being compared with each other, a weight value of a word included commonly in both documents being set to zero, the weight value of a word included only in the document of high interest being set to a non-zero value, and a string of the weight values in association with the word groups being generated as the user feature vector.

15. A computer program allowing a computer to perform an information processing method in an information processing apparatus, comprising the steps of:
generating a user feature vector specific to a user;
extracting a word group included in each of multiple data items targeted for assigning priorities and generating a data feature vector specific to each data item based on the word group extracted;
obtaining a degree of similarity between each of the data feature vectors of the multiple data items and the user feature vector; and
assigning priorities to the multiple data items to be presented to the user, according to the degree of similarity obtained;
the step of generating the user feature vector including a step of specifying a document of high interest in which a user expresses interest and a document of low interest in which the user expresses no interest, according to the user's operation among multiple documents presented to the user, a word group included in the document of high interest and a word group included in the document of low interest being compared with each other, a weight value of a word included commonly in both documents being set to zero, the weight value of a word included only in the document of high interest being set to a non-zero value, and a string of the weight values in association with the word groups being generated as the user feature vector.

16. A recording medium for recording the computer program according to claim 15 in a computer readable manner.

17. An information processing method for generating feature information specific to a user, the method specifying according to a user's operation, a document of high interest in which the user expresses interest and a document of low interest in which the user expresses no interest, among multiple documents presented to the user, a word group included in the document of high interest and a word group included in the document of low interest being compared with each other, a weight value of a word included commonly in both documents being set to zero, the weight value of a word included only in the document of high interest being set to a non-zero value, and a string of weight values associated with the word groups being generated as the user feature vector.

18. The information processing method according to claim 17, wherein different word pairs included in one document are extracted with respect to each document, and a user feature tensor including the word pairs is obtained, instead of the user feature vector.
